(19) United States
(12) Patent Application Publication
(10) Pub. No.: US 2023/0222604 A1
(43) Pub. Date: Jul. 13, 2023

(54) System for Regulating and Generating Content Across Multiple Social Media Platforms

(71) Applicant: Cross Pacific Global Inc., Hermosa Beach, CA (US)

(72) Inventor: Maria Claudio, Manhattan Beach, CA (US)

(21) Appl. No.: 18/097,178

(22) Filed: Jan. 13, 2023

Related U.S. Application Data
(60) Provisional application No. 63/299,345, filed on Jan. 13, 2022.

(51) Int. Cl. G06Q 50/00; G06Q 30/0241

(52) U.S. Cl. CPC G06Q 50/01; G06Q 30/0241

(57) ABSTRACT

New systems, methods and devices are provided for regulating and generating advertising content on a plurality of social media platforms. Content creation and management systems are provided, assisting social media platforms and advertiser users in generating advertisements compliant with social media advertising rules. In some embodiments, a content creation and management system is provided, including computer hardware and software configured to facilitate the uploading, drafting and/or review of content for an advertisement proposed by such an advertiser user for publication on one or more social media platform(s). Rule assessment software modules are provided, which determine overlapping terms, conditions and other rules applicable to advertising content and other related data. In some such embodiments, the system determines a risk level (e.g., via a “Risk Score”) that the proposed advertisement, if published as proposed, will or will not comply with social media advertising rules, and provides tools for preventing non-compliance.

### CROSS-REFERENCE TO RELATED APPLICATIONS

This application claims the benefit of priority to U.S. Provisional Application No. 63/299,345, filed Jan. 13, 2022, titled “System for Regulating and Generating Content Across Multiple Social Media Platforms,” the entire contents of which is herein incorporated by reference in its entirety.

### INTELLECTUAL PROPERTY NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. Unless otherwise stated, all trademarks disclosed in this patent document and other distinctive names, emblems, and designs associated with product or service descriptions, are subject to trademark rights. Specific notices may or may not also accompany the drawings incorporated in this application, but the material which is subject to copyright protection includes all drawings in this application, and the material subject to this notice, is not limited to those drawings.

### FIELD OF THE INVENTION

The present invention relates to systems for regulating and generating content on multiple social media platforms.

### BACKGROUND

Since the advent of the Internet, social media platforms, such as Facebook, YouTube, Twitter, TikTok, Reddit and LinkedIn, have flourished. Social media platforms include any websites and/or computer software applications (a.k.a. “Apps”) helping users of the platform (social media user(s)) share content and personal information with others. Social media users share content and personal information in a number of forms, including personal or business pages and profiles, banners, articles, vlogs, tweets, stories, posts and instant messages. Such messages may include many types of multimedia, including text, images, pre-recorded and livestreaming video, and even immersive and three-dimensional (“3D”) content. In addition, some social media platforms publish advertisements from businesses or other advertisers (“advertiser users” of the social media platforms) as a source of revenue, publishing those advertisements to other users and over the Internet. At least some social media platforms enforce terms and conditions for use of those platforms, other standards and policies for advertising, or other rules for advertiser users seeking to advertise through such a platform (“social media advertising rules”). Typically, many of such social media advertising rules may be articulated in policy statements, for example, within the “terms and conditions” or “T&Cs” for use of such a social media platform. But such social media advertising rules may be unstated, or may be partially unstated and partially stated, to the public in some instances. In some instances, social media advertising rules may be made and/or implemented in an ad hoc manner, based on the discretionary judgment of employees, or administrative users (users with greater privileges than other users to supervise and manage content) of the social media platform. In addition, on some social media platforms, ad hoc, discretionary rulemaking and implementation may be made by users of the platform. For example, on some social media platforms, content that may be inappropriate can be “flagged” for removal by any users, and such social media platforms may develop software modifying social media advertising rules, based on such flagging, as one way of assessing and incorporating “community standards.” In some such platforms, such flagging may be carried out by users with no training, in a manner that can be haphazard or even in bad faith. For example, a user that is a competitor of an advertiser user may seek only to hurt the reputation of the advertiser user, or undermine the content of an advertisement, in some instances, by inappropriately flagging the advertisement, and/or falsely alleging that it contains inappropriate content, violative of terms and conditions of social media platforms.

Efforts have been made to deal with the issue of determining when bad faith flagging and/or commenting takes place. At least some social media platforms do not immediately remove flagged advertisements, for example, requiring multiple users or other content moderation sources, from different locations, to flag the same advertisement before it is taken down (i.e., removed, or no longer published, on the social media platform). Thus, even when flagged and taken down, the allegedly inappropriate content may still reach an audience of many users, prior to flagging. Conversely, although social media platforms may allow an advertiser user to respond to false allegations, and restore inappropriately removed advertising content, such processes take time to implement. Furthermore, advertiser users of social media platforms often lack in-depth knowledge of the social media advertising rules and procedures applicable to their content, and may not avail themselves of those processes at all.

As a result, advertising may not reach its audience, and revenue may be lost. Advertiser users of social media platforms are often surprised to find their advertisements taken down, and may even have their accounts on the social media platforms blocked, based on opaque advertising rules. This has been a long-felt problem in the social media industry, with no sufficiently effective solution.

It should be understood that the disclosures in this application related to the background of the invention, in, but not limited to this section titled “Background,” do not necessarily set forth prior art or other known aspects exclusively, and may instead include art that was invented concurrently or after the present invention and conception, and details of the inventor's own discoveries, work and work results.

### SUMMARY OF THE INVENTION

New systems, methods and devices are provided for regulating and generating content on one or more social media platform(s). In some aspects, content creation and management systems are provided, assisting social media platforms and advertiser users in the regulation and generation of advertisements compliant with social media advertising rules.

In some embodiments, a content creation and management system (the “system”) is provided, including a control system with specialized computer hardware and software configured to facilitate the uploading, drafting and/or review of content for an advertisement proposed by such an advertiser user for publication on one or more social media platform(s). In some embodiments, the content creation and management system permits a user (such as an advertiser user) to upload and/or review content for such a proposed advertisement prior to publication, using a pre-publication uploading and review tool. In some such embodiments, the system may, at least in part, carry out and/or aid in such a review, in various embodiments, and determine a risk level (e.g., via a “Risk Score”) that the proposed advertisement will or will not comply with social media advertising rules, and provide tools for remediating the non-compliance, as will be discussed in greater detail below.

In some embodiments, the system assesses terms, conditions and other rules impacting content advertised on social media platform(s). In some embodiments, the system includes a natural language processing module, which processes human language of social media advertising rules set forth in policy statements (e.g., terms and conditions) of the social media platform(s). Generally speaking, the system can aid an advertiser user in managing proposed advertisements to be published on a wide variety of social media platforms. In some embodiments, such a natural language processing module assesses matching language between multiple different social media advertising rules adopted by different social media platforms, and the system generates a new, main rule set for policy statements, which includes only one instance of the matching language. In some embodiments, such a natural language processing module assesses common rules, and/or overlapping rule aspects found in multiple different social media advertising rules adopted by different social media platforms, and the system generates a new, main rule set for policy statements, which includes only one instance of the common rules, and/or overlapping rule aspects.

In some embodiments, a human supervisor user with legal and/or computer training may, alternatively or in addition to such processing by the natural language processing module, edit the new, main rule set for policy statements. Also, in some such embodiments, the system may present tools for such a human supervisor user to view the proposed advertisement, and may create new GUI tools which are then provided to the advertiser user, and guide the advertiser user regarding the application of such a new, main rule set based on policy statements, such as any or all of the GUI tools set forth in the present application. However, in some embodiments, as will be discussed in greater detail below, the system generates such GUI tools, instead of, or in addition to, such a human user.

As will be discussed in greater detail below, other sources of social media advertising rules, besides policy statements and rules set forth in human language, are also determined by the system, in some embodiments, and the new, main rule set for policy statements may be combined with other such rules, and rendered as a final application rule set, in some such embodiments. For example, in some embodiments, a user base rule module is included in the system, which creates and/or assesses rules based on community standards (e.g., based on flagging, commenting, suggestions, other user behavior, and patterns thereof). In any of the above embodiments, the system may create and apply an algorithm for determining whether any and all of such rules, of a final application rule set, prohibit any of the proposed advertising content. In some embodiments, the control system of the content creation and management system includes a rule application module and/or a risk assessment module, which applies an algorithm to determine a Risk Score for the proposed advertisement, representing a determination of a probability that the proposed advertisement will not comply with the final application rule set, and/or be removed by one or more social media platforms that the advertiser user has selected for publication of the proposed advertisement. In some embodiments, a human user with legal and/or computer training may, alternatively or in addition to such processing by the natural language processing module, edit the final application rule set.

In determining whether social media advertising rules prohibit any of the proposed advertising content, in some embodiments, the system then generates tools (e.g., graphical user interface (“GUI”) tools, provided on a display) to guide the advertiser user regarding aspects of the advertisement that have a heightened risk of non-compliance with the new, main rule set. In some embodiments, the system includes a rule application module, which creates an algorithm for determining the likelihood that each rule of the new, main rule set prohibits content of a proposed advertisement (i.e., that the content is “non-compliant”). The system then applies that algorithm to content of a proposed advertisement, and generates GUI tools to the advertiser user, in some embodiments. In some embodiments, such GUI tools include a warning(s), if and when some aspect(s) or part(s) of the proposed advertisement content has a high risk of being so prohibited (i.e., has a high “risk of non-compliance”). For example, in some embodiments, such a GUI tool may be in the form of a colored highlight of a word, phrase or image within the content. As another example, in some embodiments, such a GUI tool may be in the form of a nearby indicator, such as a red flag or “stop” sign icon, appearing on or about content of a proposed advertisement on a display of the system. In some embodiments, one or more GUI tool(s) identifies said terms, conditions and other rules that said proposed advertisement will not comply with. In some embodiments, the system generates a new version of said proposed advertisement, e.g., by suggesting substitute content associated with a decreased likelihood that said a proposed advertisement will any of the rules discussed above, and presents additional GUI tools for the user to accept and publish, or further modify, the suggested substitute content. In some embodiments, GUI tools identify which particular rule(s), and which social media platform(s) having such rule(s), are the basis for some aspect(s) or part(s) of the proposed advertisement content having a high risk of non-compliance. In some such embodiments, an advertiser user is provided with a GUI tool to remove such social media platforms previously designated for publication of the proposed advertisement, in a new designation of social media platforms, and re-run any of the processes above.

In some embodiments, if, after the processes discussed above, a particular proposed advertisement uploaded for review registers a risk score below a particular threshold (e.g., below 10% or 5%, meaning, respectively, less than a 10% or 5% probability of non-compliance) known as a “threshold for passing”, the proposed advertisement may be automatically published on each of the social media platforms selected by the advertiser user. However, in some embodiments, such a threshold is 0%, meaning that there must be no association with phrases, terms, keywords, image elements, etc., indicating any risk of non-compliance with any of the rules of the selected social media platforms. In some such embodiments, the system provides a separate GUI for owners or other stakeholders in one or more of the social media platform(s) selected by the advertiser user, and the owners or other stakeholders can designate the particular threshold for passing, applicable to publishing proposed advertisements on their social media platform(s). However, in some embodiments, an advertiser user may select to publish a proposed advertisement, even if a risk score above any particular threshold has been so indicated (e.g., with a “publish at risk” GUI button).

In some embodiments, a supplemental risk score may be generated by the system, based on an increased, or decreased likelihood that an advertiser is uploading advertising content that is non-compliant, based on a review of a website owned by advertiser user. In some such embodiments, the risk score may include, or be adjusted by, the supplemental risk score. In some embodiments, the system includes a web crawler and scraper, which copy and process content held on such a website, applying a supplemental risk assessment algorithm. In some embodiments, such a supplemental risk assessment algorithm processes content from both the website and the proposed advertising content.

### Canons of Construction

Where any term is set forth in a sentence, clause or statement (“statement”) in this application, each possible meaning, significance and/or sense of any term used in this application should be read as if separately, conjunctively and/or alternatively set forth in additional statement(s), after the sentence, clause or statement, as necessary to exhaust the possible meanings of each such term and each such statement.

It should also be understood that, for convenience and readability, this application may set forth particular pronouns and other linguistic qualifiers of various specific gender and number, but, where this occurs, all other logically possible gender and number alternatives should also be read in as both conjunctive and alternative statements, as if equally, separately set forth therein.

The embodiments set forth in detail in this application are to ease the reader's understanding of inventions set forth herein and, as such, are only examples of the virtually innumerable number of alternative embodiments falling within the scope of the application. No specific embodiment set forth in this application should be read as limiting the scope of any claimed inventions.

These and other aspects of the invention will be made clearer below, in other parts of this application. This Summary, the Abstract, and other parts of the application, are for ease of understanding only, and no part of this application should be read to limit the scope of the invention, whether or not it references matter also set forth in any other part.

### BRIEF DESCRIPTION OF THE DRAWINGS

The features and advantages of the example embodiments of the inventions presented herein are generally directed to new systems, methods and devices are provided for regulating and generating content on a plurality of social media platforms, which are now described herein. These and other aspects will become more apparent from the detailed description set forth below when taken in conjunction with the following drawings. This description is not intended to limit the application to the embodiments presented herein, which are only examples of the virtually unlimited possible embodiments falling within the scope of the present application. In fact, after reading the following description, it will be apparent to one skilled in the relevant art(s) how to implement the following example embodiments in alternative embodiments, including any possible order, number, combination or other arrangement of any or all aspects, components, sub-components and/or relationships thereof. The following order, number, combination or other arrangement of aspects, components, sub-components and/or relationships are non-limiting.

FIG. 1 is a diagram of some elements of an example content creation and management system for regulating and generating content on a plurality of social media platforms, in accordance with some embodiments.

FIG. 2 is a process flow diagram, illustrating several example steps that may be carried out by a control system, such as the example control system set forth below, in reference to FIG. 5, in accordance with some additional embodiments.

FIG. 3 depicts an example GUI, including some example GUI tools, which may be created and utilized by users of a system for regulating and generating content on a plurality of social media platforms, in accordance with some embodiments.

FIG. 4 depicts some additional example GUI tools, which may be created and utilized by users of a system for regulating and generating content on a plurality of social media platforms, in accordance with some embodiments.

FIG. 5 is a schematic block diagram of some elements of a control system in accordance with some example embodiments of the invention.

FIG. 6 is a process flow diagram, illustrating several additional example steps that may be carried out with the aid of a control system, such as the example control system set forth above, in reference to FIG. 5, in accordance with some additional embodiments.

FIG. 7 is a process flow diagram, illustrating several example steps that may be carried out by a control system, such as the example control system set forth below, in reference to FIG. 5, in accordance with some additional embodiments.

FIG. 8 depicts some additional example GUI tools, which may be created and utilized by users of a system for regulating and generating content on one or more social media platform(s), in accordance with some embodiments.

FIG. 9 depicts some additional example GUI tools, which may be created and utilized by users of a system for regulating and generating content on one or more social media platform(s), in accordance with some embodiments.

FIG. 10 depicts some additional example GUI tools included within example GUI, which may be utilized by users of a system for regulating and generating content on one or more social media platform(s), in accordance with some embodiments.

FIG. 11 depicts some additional example GUI tools, included within example GUI, which may be utilized by users of a system for regulating and generating content on one or more social media platform(s), in accordance with some embodiments.

FIG. 12 depicts an additional example GUI including some additional example GUI tools included within it which may be utilized by users of a system for regulating and generating content on one or more social media platform(s), such as any of such systems set forth in the present application, in accordance with some embodiments.

FIG. 13 depicts an additional example GUI, including some additional example GUI tools included within it which also may be utilized by users of a system for regulating and generating content on one or more social media platform(s), such as any of such systems set forth in the present application, in accordance with some embodiments.

FIG. 14 depicts an example GUI, including some example GUI tools, which may be utilized by users of a system for regulating and generating content on one or more social media platform(s), such as any of such systems set forth in the present application, in accordance with some embodiments.

FIG. 15 depicts another example GUI, including additional example GUI tools, which may be utilized by users of the system for regulating and generating content on one or more social media platforms, in accordance with some embodiments.

### DETAILED DESCRIPTION OF THE INVENTION

The features and advantages of the example embodiments of the invention presented herein are directed to new systems for regulating and generating content on a plurality of social media platforms and, in particular, new systems for regulating and generating advertising content that complies with rules set forth on those social media platforms, which are now described herein. These and other aspects will become more apparent from the detailed description set forth below when taken in conjunction with the following drawings. This description is not intended to limit the application to the embodiments presented herein, which are only examples of the virtually unlimited possible embodiments falling within the scope of the present application. In fact, after reading the following description, it will be apparent to one skilled in the relevant art(s) how to implement the following example embodiments in alternative embodiments, including any possible order, number or other arrangement of components and sub-components (the following order, components, subcomponents and/or relationships being non-limiting).

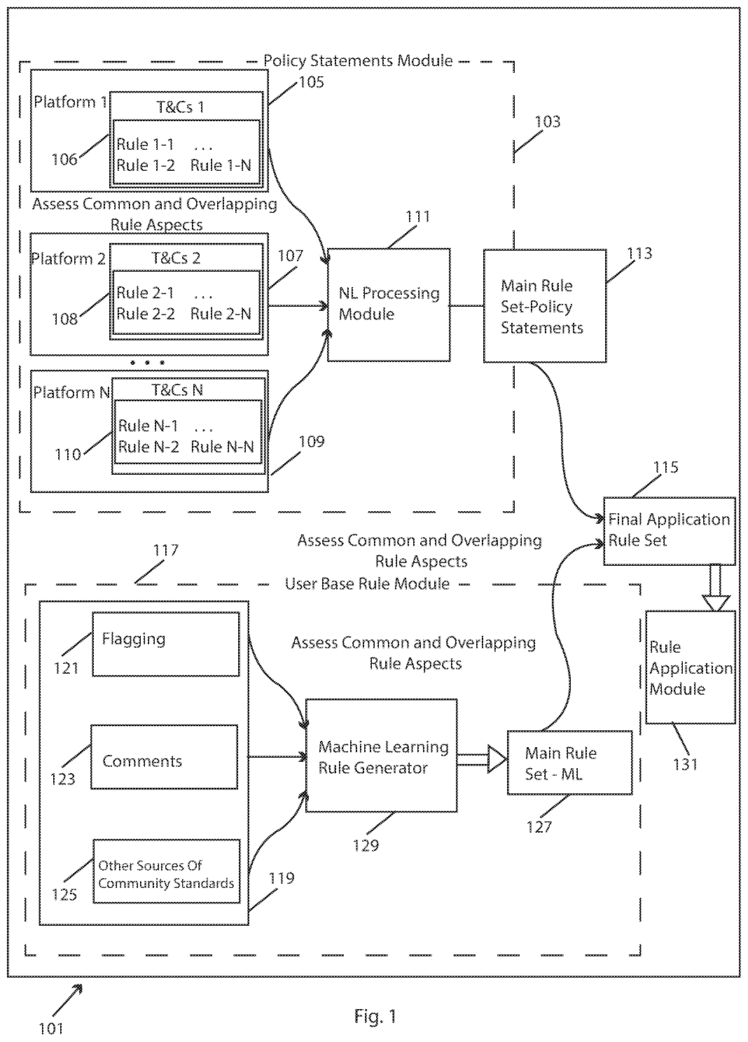

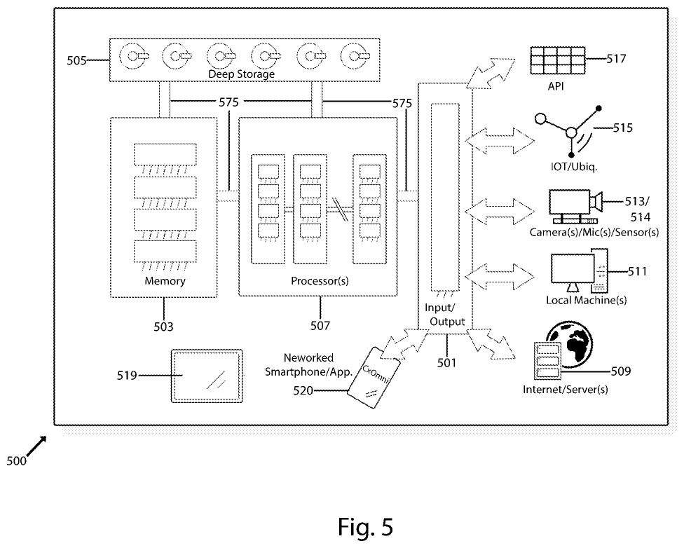

FIG. 1 is a diagram of some elements of an example content creation and management system 101 for regulating and generating content on a plurality of social media platforms, in accordance with some embodiments. In some embodiments, the example system 101 includes a control system including specialized computer hardware and software configured to carry out the aspects set forth herein. For example, in some embodiments, such a control system may be the example control system set forth below, in reference to FIG. 5. In some embodiments, system 101 includes (e.g., within such a control system) multiple subsystems and/or software modules (“modules”), carrying out different processes of the system. For example, in some embodiments, system 101 includes a policy statements module 103, with at least some aspects dedicated to discovering, scraping and processing human language of social media advertising rules set forth in policy statements by social media platform(s), as such policy statements are discussed elsewhere in this application. For example, in some embodiments, such policy statements are written in terms and conditions of the social media platform(s). In the example provided, a first social media platform is provided, example platform 105, which includes a web page or other publication of social media advertising rules 106, which may be labeled, in some embodiments (e.g., “Rule 1-1,” “Rule 1-2,” through a final rule, “Rule 1-N.”) Also in the example provided, a second social media platform is provided, example platform 107, which includes a web page or other publication of social media advertising rules 108, which may be labeled, in some embodiments (e.g., “Rule 2-1,” “Rule 2-2,” through a final rule, “Rule 2-N.”) Also in the example provided, any number of additional social media platforms is provided, all the way through an example “Nth” platform 109, each of which similarly includes a web page or other publication of social media advertising rules 110, which may be labeled, in some embodiments (e.g., “Rule N−1,” “Rule N−2,” through a final rule, “Rule N−N.”) In some such embodiments, the policy statements module 103 reads and copies all policy statements and other sources of such rules written in human language by social media platforms, which social media platforms have been selected by an advertiser user of the system for processing and publication of proposed advertising content of the advertiser user (e.g., using GUI tools, such as those set forth in this application). In some embodiments, such a policy statements module 103 includes a natural language processing module 111 (or sub-module), which reads and compares language from each of such rules, from each selected social media platform, to each other. In some embodiments, if substantially similar language (e.g., a particular percentage of same words, same word order, in a minimum length phrase, such as 7 or 10 words) is found in multiple different social media advertising rules, the natural language processing module de-duplicates the language of those social media rules, or de-duplicates the rules themselves. In some embodiments, such a comparison yields a similarity above a particular confidence interval, the natural language processing module determines that such a match has occurred. The system 101 then generates, with the policy statements module 103 and natural language module 111, a new, main rule set 113 based on all of the policy statements, which new, main rule set 113 includes only one instance of the matching language, in some embodiments (in other words, the natural language module creates a single, “bridging rule”). In some embodiments, such a natural language processing module 111 otherwise assesses the presence of common rules, and/or overlapping rule aspects found in multiple different social media advertising rules adopted by different social media platforms, and the new, main rule set 113 includes only one instance of the common rules, and/or overlapping rule aspects. In any event, once the new, main rule set 113 has been generated, the system 101 may then combine that new, main rule set with other social media advertising rules, derived from other sources, as discussed further below.

In some embodiments, the main rule set 113 may include sub-parts, or collections of rules, based on selected audiences (e.g., by demographics) and whether the rules apply to the selected demographic (e.g., by a demographic parameter or range thereof, to which each rule is applicable). In some embodiments, the user may select such an audience (e.g., with a demographic data entry tool or demographic parameter selection tool), and the system publishes the social media advertisement only to social media platform users matching those selections (e.g., via an API provided on each social media platform.)

In some embodiments, a human supervisor user with legal and/or computer training may, alternatively or in addition to such processing by the natural language processing module, edit the new, main rule set for policy statements. Also, in some such embodiments, the system may present tools for such a human supervisor user to view the proposed advertisement, and may create new GUI tools which are then provided to the advertiser user, and guide the advertiser user regarding the application of such a new, main rule set based on policy statements, such as any or all of the GUI tools set forth in the present application. However, in some embodiments, as will be discussed in greater detail below, the system generates such GUI tools, instead of, or in addition to, such a human user.

As mentioned above, other sources of social media advertising rules, besides policy statements and rules set forth in human language, are also determined by the system, in some embodiments. In some embodiments, such other sources create rules that may or may not be articulated in human language (and therefore, may be and processed by the natural language processing module, in some embodiments) but are private, and/or non-public, having not been included in policy statements by the social media platforms. And, also as discussed above, in some such embodiments, the new, main rule set for policy statements may be combined with other such rules, and rendered as a final application rule set 115, in some such embodiments. For example, in some embodiments, a user base rule module 117 is included in the system, which creates and/or assesses rules based on community standards derived from various use activities 119 monitored by the system. For example, in some embodiments, user's flagging 121 of content as inappropriate, over time, may be one such activity. In some embodiments, user's negative commenting 123 regarding content, over time, may be another such activity. In some embodiments, other sources of community norms 125, such as negative statements outside the social media platforms selected by the advertiser user regarding social media content, may be another such activity. In any event, data may be gathered by the system 101 regarding the nature of such content, and matching or common elements in such content may be considered prohibited content, in one or more user base rule(s), developed and recorded by the system as a new, main rule set 127. In some embodiments, such user base rule(s) are determined by an artificial intelligence module, such as a machine learning rule generator 129.

In any of the above embodiments, the system may create and apply an algorithm for determining whether any and all of such rules, of the final application rule set 115, prohibit any proposed advertising content. In some embodiments, the control system of the content creation and management system includes a rule application module 131 and/or a risk assessment module (not pictured), which applies an algorithm to determine a risk score for the proposed advertisement, representing a determination of a probability that the proposed advertisement will not comply with the final application rule set, and/or be removed by one or more social media platforms that the advertiser user has selected for publication of the proposed advertisement.

In some embodiments, a human user with legal and/or computer training may, alternatively or in addition to such processing by the natural language processing module, edit the final application rule set.

Of course, the exact arrangements of particular modules, processes, and orders and number thereof, set forth above are not limiting to the scope of this application, and are only examples of the virtually unlimited alternative embodiments falling within the scope of this application. Such alternative embodiments will be readily apparent to those of skill in the art.

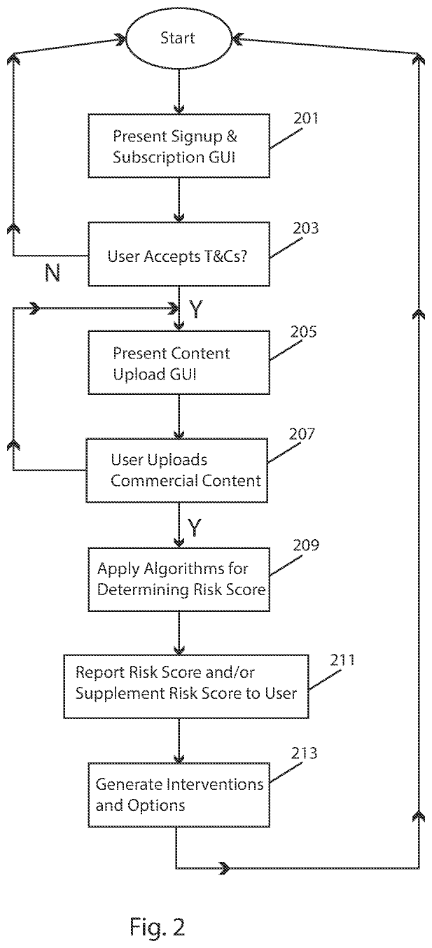

FIG. 2 is a process flow diagram, illustrating several example steps 200 that may be carried out by a control system, such as the example control system set forth below, in reference to FIG. 5, of a system regulating and generating content on a plurality of social media platforms, in accordance with some additional embodiments.

Beginning with step 201, in some embodiments, the control system first presents a GUI for an advertiser user, such as a GUI including sub-tools for creating an advertiser user account on the control system. In some embodiments, such sub-tools and an advertiser user account require the entry of secure login credentials (e.g., with a username, password and/or 2-factor authentication method) prior to providing account access, or other access to further, encrypted resources of the control system, such as any of the additional resources discussed in this application. In some embodiments, the advertiser user may be presented with options for different types of advertiser user accounts, such as accounts with short- or long-term durations and/or accounts. For example, some types of advertiser user accounts may require a one-time payment or free trial, for processing and publishing a single social media advertisement, while other types of advertiser user accounts may require a payment for less limited use of the system, over a longer period of time (e.g., a month-by-month or one-year subscription), in various embodiments. In some embodiments, control system may implement a multiple-tiered (e.g., freemium) model, in which a lower level of accounts require a lower fee, or no fee, but provide less resources, less features (e.g., omitting GUI tools for revising advertising content) than higher lever account types, available for a higher fee. In some embodiments, the control system then proceeds to step 203, in which the control system requires the user to accept legally binding terms and conditions (e.g., via electronic signature) for creating, configuring and using the account for purposes set forth in this application. If the advertiser user accepts all required terms and conditions, the control system proceeds to step 205, in some embodiments, in which it presents a GUI to the advertiser user with GUI tools facilitating the uploading and processing of proposed advertising content, in accordance with any and/or all of the aspects set forth in the present application for regulating and generating content on a plurality of social media platforms, in various embodiments. If, however, at step 203, the advertiser user did not accept the terms and conditions, the user may be denied access to any of those GUI tools (e.g., with different GUI aspects informing the user that no account has been set up and that the user has been barred from access to those GUI tools), and the control system returns to the starting position.

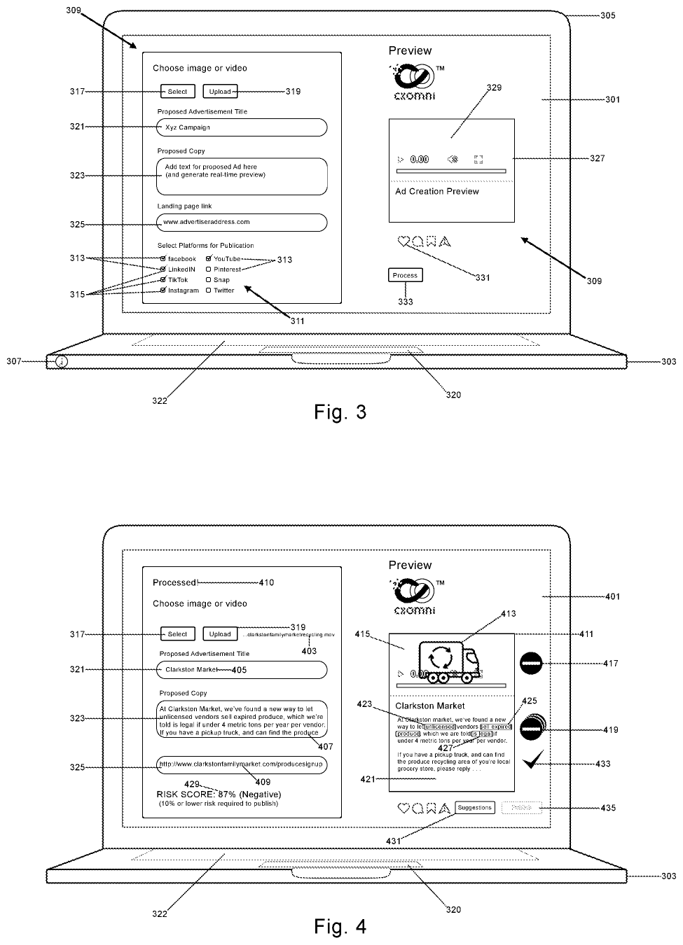

Assuming that the user has accepted the terms and conditions, and the control system has proceeded to step 205, as discussed above, the control system may proceed to step 207, in which it receives any and all commercial content created and/or uploaded by the user using the GUI tools, which content the user may wish to be included in a proposed advertisement for publication through the system to multiple social media platforms. In some embodiments, the GUI also presents a selection GUI tool, which allows the user to review and designate which social media platforms he, she or it seeks to publish a proposed advertisement including the created and/or uploaded content. Examples of such GUI tools are provided below, in reference to FIG. 3. If no content is created or uploaded, or, in some embodiments, if the advertiser user selects a “cancellation” GUI tool, the control system may return to step 205, in some embodiments.

Assuming that the advertiser user has created and/or uploaded content and, in some embodiments, pressed a “review” or “review and publish” GUI tool, the control system may next proceed to step 209, in which it takes a final application rule set, such as the final application rule set 115 discussed in reference to FIG. 1, and applies an algorithm for determining whether any and all of such rules, of the final application rule set 115, prohibit any proposed advertising content, as discussed elsewhere in this application. In some embodiments, the control system includes a rule application module, such as the rule application module 131 set forth in reference to FIG. 1, to determine a risk score, and then reports that risk score back to the advertiser user in subsequent step 211.

In some embodiments, in step 213, the control system also generates GUI tools for intervening and improving the risk score for the proposed advertising content. For example, some such GUI tools include a warning(s), if and when some aspect(s) or part(s) of the proposed advertisement content has a high risk of being so prohibited (i.e., has a high risk of “non-compliance”). As another example, in some embodiments, such a GUI tool may be in the form of a colored highlight of a word, phrase or image within the content. As another example, in some embodiments, such a GUI tool may be in the form of a nearby indicator, such as a red flag or “stop” sign icon, appearing on or about content of a proposed advertisement on a display of the system. In some embodiments, one or more GUI tool(s) identifies said terms, conditions and other rules that said proposed advertisement will not comply with. In some embodiments, the system generates a new version of said proposed advertisement, e.g., by suggesting substitute content associated with a decreased likelihood that said a proposed advertisement will any of the rules discussed above, and presents additional GUI tools for the user to accept and publish, or further modify, the suggested substitute content. In some embodiments, such substitute content includes a version of the proposed social media advertisement in which the aspect(s) or part(s) of the proposed advertisement content that has a high risk of “non-compliance” is deleted, but not so replaced. In some embodiments, GUI tools identify which particular rule(s), and which social media platform(s) having such rule(s), are the basis for some aspect(s) or part(s) of the proposed advertisement content having a high risk of non-compliance. In some such embodiments, an advertiser user is provided with a GUI tool to remove such social media platforms previously designated for publication of the proposed advertisement, in a new designation of social media platforms, and re-run any of the processes above.

The control system then returns to the starting position, in some embodiments.

It should be understood that the above steps, and number and order of steps, is exemplary only of certain embodiments set forth in this application, and are not intended to limit the application in any way. In fact, virtually unlimited alternative orders, numbers, instances of the above steps, in addition with countless additional and alternative steps may be performed, within the scope of the present application and inventions herein, as will be readily apparent to those of skill in the art.

FIG. 3 depicts an example GUI 301, including some example GUI tools, which may be created and utilized by users of a system for regulating and generating content on a plurality of social media platforms (the “system”), in accordance with some embodiments. As with other example GUIs and GUI tools set forth in the present application, in some embodiments, GUI 301 and any such GUI tools may be provided within, and controlled by, a control system including computer hardware and software, such as, but not limited to, the example control system set forth below, in reference to FIG. 5, in some embodiments. In some embodiments, such a control system may include, or be included within, a computer 303, including local computer hardware, such as local display 305, and specialized software (e.g., a desktop software application, or “App”) which, when executed, causes some of the steps and processes set forth in this application to take place. But, if so, preferably, in some embodiments, computer 303 is connected for communications (e.g., to the internet, via wireless communications antenna 307) with another control system including computer hardware and software (e.g., a remote server), with additional specialized software (e.g., an SaaS web application) which, when executed, causes some of the steps and processes set forth in this application to take place. In some embodiments, a smartphone or other peripheral device-based app is included, as a part of, or in communication with, a control system included in case 101. However, the example of a local computer 303, and the example format of a laptop computer as pictured, is only one example of the virtually unlimited alternative forms and numbers of local and network-accessible computers that may be used to carry out aspects of the inventions set forth in this application. For example, in some embodiments, multiple such local computers are provided. As another example, no local computer is provided, and, instead, all GUI tools and processes may be carried out on a single computer, which may or may not be a part of a network, in some embodiments. As another example, the format of a local computer may instead be a peripheral device, such as a smartphone or other personal digital assistant device, in some embodiments. In any event, any such computer may relay instructions and other information and monitor user selections, data input, and other user behavior, through GUI tools, such as the example GUI tools set forth below, to aid in carrying out the processes and steps set forth in this application.

In some embodiments, and assuming the advertiser user has already created and logged in to its account, as set forth in steps 201 and 203, discussed above, such GUI tools may be such as those shown as example GUI tools 309. Generally speaking, GUI tools 309 facilitate an advertiser user creating and publishing a social media advertisement, and reducing the risk that such a social media advertisement will result in adverse impacts, such as ultimately being taken down by one or more social media platforms selected by the advertiser user for publishing such a social media advertisement, and negatively impacting other users of the social media platform, in the interim. For example, one such GUI tool is pictured as social media platform designation tool 311, which, in some embodiments, permits the advertiser user (not pictured, but may be a human operator of computer 303 or an owner of the account created, in some embodiments) to select any of several available social media platforms, the social media advertising rules of which are accessible and processed by the system, as discussed above, in reference to FIGS. 1 and 2. To aid in selecting any of the available social media platforms, social media platform designation tool 311 may include several sub-tools, such as example check-box indicators 313. By “clicking on” one or more of check-box indicators 313, in some embodiments, the social media platform listed next to such check-box indicators will be selected, as may be confirmed by the appearance of a “check mark” within that check box indicator, as pictured in the example selected check box indicators 315. Because those selected social media platforms have been so selected, the social media advertising rules, as discussed above, will be included within the processes to be carried out, as discussed further below (and throughout this application) if and when the advertiser user continues to use GUI 301 and the system to create, review and/or publish a social media advertisement. After making such selections, the advertiser user may then begin such a social media advertisement creation processes using others of GUI tools 309, e.g., beginning with media file selection tool 317, and media file upload tool 319, in some embodiments. Media file selection tool 317 and media file upload tool 319 are each shown as button-format GUI tools which can be activated (e.g., by the advertiser user “clicking on” them, using an input device of computer 303, such as example track pad 320). In some embodiments, when so clicked on and activated, media file upload tool 319 allows the user to select a file(s) (e.g., from any data storage device available through computer 303) for uploading as a source of content for a proposed social media advertisement. Once so selected, in some embodiments, the advertiser user then may click on file upload tool 319, which input causes the computer 303 to upload the file(s) (e.g., to a control system managed on a remote server) and make it available as content for a proposed social media advertisement, as will be discussed further below. In some embodiments, the advertiser user also may create a title for such a proposed social media advertisement, for example, using title data entry window 321, in some embodiments. In some embodiments, title data entry window 321 may be pre-populated with a file name of the file uploaded. In some embodiments, a user may click on data entry window 321 and enter text creating a title (e.g., using example alphanumeric keyboard 322, in some embodiments. Similarly, the advertiser user may create text for advertisement copywriting for a main body of the social media advertisement, by clicking on copywriting data entry window 323, and again entering text creating such copywriting, e.g., again using keyboard 322, in some embodiments. In some embodiments, the advertiser user may enter a link (e.g., a URL) for a website or other resource, for example, using landing page data entry window 325. In some embodiments such a link may be included in the proposed social media advertisement, to allow viewers of the social media advertisement to quickly navigate to the advertiser user's webpage or other resource, when viewing the social media advertisement. As mentioned above, in some embodiments, the system accesses and scrapes a website or other resource of the advertiser user (e.g., for determining a risk score, or supplemental risk score), may then be generated by the system, based on a processing content (e.g., using rule application module 131) of the website of (e.g., owned by) the advertiser user. In some such embodiments, such a website may be the webpage or other resource so entered.

In some embodiments, the system is configured to generate a preview of the proposed social media advertisement, including and showing the advertising copywriting, content from the uploaded file(s) and title, among other possible elements, e.g., within a preview displaying tool 327, in some embodiments. In some embodiments, preview displaying tool 327 includes a viewing area 329 for viewing advertising art, such as an image(s) and/or video(s), which may be included in the proposed social media advertisement. In some embodiments, drafts of the proposed social media advertisement may be saved, sent to third parties, annotated, or otherwise developed and shared, using draft social media advertisement sharing and commenting tools 331. The proposed social media advertisement may then be subjected to additional editing by the advertiser user, at a later time. In any event, once satisfied with the substance and preview, the advertiser user may then trigger the system to process the content, copywriting and/or linked content, as discussed in greater detail elsewhere in this application, by clicking on, and activating, a process-initiating GUI tool, such as example process button 333, in some embodiments. For example, in some embodiments, such a process-initiating GUI tool causes the system to carry out at least some aspects of step 209, step 211 and/or step 213, using rule application module 131, each of which are discussed above, in some embodiments. Example results of such processing will be discussed in further detail, below, in reference to FIG. 4.

FIG. 4 depicts some additional example GUI tools, included within example GUI 401, provided on the same computer 303, which may be created and utilized by users of the system for regulating and generating content on a plurality of social media platforms, in accordance with some embodiments. As with other example GUI 301, in some embodiments, GUI 401 and any such GUI tools included within it may be provided and controlled by a control system including computer hardware and software, such as, but not limited to, the example control system set forth below, in reference to FIG. 5, in some embodiments. In some embodiments, GUI 401 includes several of the same GUI tools set forth above, with reference to FIG. 3—for example, media file selection tool 317, media file upload tool 319, title data entry window 321, copywriting data entry window 323 and landing page data entry window 325. However, after the processing, discussed above, following the advertiser user's activating example process button 333, the additional example GUI tools have been created by the system. Some such GUI tools may be modified relative to how they were manifested in FIG. 3, reflecting changes entered by the advertiser user. For example, a file indicator sub-tool 403, which displays the file name of a file uploaded by the advertiser user, using media file selection tool 317 and media file upload tool 319, is now included in GUI 401. As another example, title data 405, entered by the advertiser user in title data entry window 321, is now shown. As another example, copywriting text entered by the advertiser user has been entered and now appears as example copywriting text tool 407. As another example, a URL has been entered within landing page data entry window 325, and appears as entered URL indicator 409. However, other GUI tools may be newly-introduced, additional GUI tools. One example of such an additional GUI tool is shown as example processing completion indicator 410, which indicates to the advertiser user that such processing has been completed.

In some embodiments, a new form of preview displaying tool 411 now appears, reflecting changes in the content and video created and uploaded by the advertiser user, and rendering a simulation of the appearance and content of the proposed social media advertisement, in some embodiments. Because the advertiser user has uploaded a video file, using media file upload tool 319, in the example pictured, a preview of the video, including at least one image 413 (e.g., of a recycling truck) now appears in a video display area 415 of the preview displaying tool 411. In some embodiments, such images and video files are scanned by the system, which then determines whether there is a risk that prohibited content is included within the proposed social media advertisement (e.g., by rule application module 131 of a control system of the system), and, in some embodiments, a level of that risk. As an example, if the rule application module includes a rule that any advertisement on a particular, selected social media platform (e.g., Facebook) involves an activity requiring a license or certification, and, further, that certain image types are associated with activities requiring a license or certification, a prohibited image content alert 417 may be generated, in some embodiments. In some embodiments, such a prohibited image content alert 417 may be removed, however, even if such an image is found to be uploaded by the advertiser user, if and when the advertiser user furnished information establishing that it has such a required license and/or certification. Thus, in the example pictured, the rule application module includes image examples or templates for waste removal and treatment activities, associated with a required license and/or certification for waste removal. In some embodiments, because such examples closely correlate to the image(s) provided by the user in the video content, prohibited image content alert 417 has been generated. Similarly, in some embodiments, if copywriting text 407 contains key words or phrases, or similar phrases, to those associated by the system with activities requiring a license or certification, one or more prohibited copywriting content alerts 419 may be generated, in some embodiments. In some embodiments, such prohibited copywriting content alerts 419 are provided, one each, for any such key words or phrases or similar phrases, as may be identified by the rule application module. In some embodiments, the words or phrases, or similar phrases, are identified and called out within a text preview area 421 of preview displaying tool 411, for example, by language risk highlighting box 423, language risk highlighting box 425 and language risk highlighting box 427. All of the above alerts and highlights are examples of feedback and suggestions from the system, instructing the advertiser user to address and ameliorate risk-creating issues, which are contributing to a risk score 429. In some embodiments After receiving such feedback and suggestions from the system, in such a form, the advertiser user may then edit the copywriting, using copywriting data entry window 323, and the system will again process the proposed advertisement, as so edited. In some embodiments, such suggestions are only made by the system after the user activates a suggestion request button 431. In some embodiments, as discussed above, the system generates suggested, alternative text, replacing the words or phrases, or similar phrases, in a revised version of the proposed social media advertisement (not pictured), upon the advertiser user activating suggestion request button 431.

In some embodiments, if copywriting, or other element(s) of the proposed social media advertisement do not trigger such alerts, or, in some embodiments, reduce the overall risk score of the proposed social media advertisement, a positive risk indicator, such as example beneficial element indicator 433 (shown in the example as a check mark), may be provided on or about that copywriting, or other element(s).

In some embodiments, if the content, images and other elements of the proposed social media advertisement, when processed as discussed in this application, generate a risk score below a particular threshold, the advertiser user may then immediately publish the proposed social media advertisement, on each of the selected social media platforms, as discussed above. In some embodiments, an API provided by another party may be used to aid the system in immediately and directly publishing the social media advertisement across the selected social media platforms. Thus, in some embodiments a GUI tool for the advertiser user to command such publishing, such as publication button 435, is included. However, in some embodiments, each selected social media platform may be required to sign a legal contract with the owner of the system, to permit such immediate publication upon command. In some embodiments, as another option, an advertiser user may deselect social media platforms (previously indicated using social media platform designation tool 311), to eliminate the selection of social media platforms not agreeing to expedited and/or more limited review of the social media advertisement prior to publication. Similarly, in some embodiments, the advertiser user may so eliminate the selection of social media platforms, rules associated with which are leading to an adverse risk score (e.g., a risk score below a required threshold for publication) in some embodiments.

Following the publication of the social media advertisement, in some embodiments, the system provides ongoing statistics and other data related to the publication of the social media advertisement to a number of users of the social media platforms selected (a.k.a, a “campaign”). For example, in some embodiments, such data may include key performance indicators (“KPIs”) relevant to the effectiveness of the social media advertisement, on each social media network. In some embodiments, multiple campaigns may be so managed by a single advertiser user, who may then adopt changes based on the differing results of each such campaign. In some embodiments, the system may generate additional suggestions for revising the content, data and/or copywriting of the social media advertisement(s), based on results of the different campaigns. For example, in some embodiments, the control system includes a machine learning module, using data related to KPIs demonstrating better outcomes than others as a positive outcome, and then uses examples of advertisements with such a positive outcome to evolve an algorithm including functions that define differences from example advertisements that have a more negative outcome, over time. The control system may then apply that algorithm to generate suggestions for changes, based on elements identified as correlated with positive and negative outcomes in new, proposed social media advertisements, in some embodiments. In some embodiments, a flagged advertisement, or other advertisement determined to be non-compliant are such example advertisements that have a more negative outcome. In some such embodiments, a flagged advertisement, or other advertisement determined to be non-compliant with social media platform rules, are such example advertisements that have a more negative outcome are used to create a revised risk score, based on such a machine learning algorithm.

FIG. 5 is a schematic block diagram of some elements of a control system 500, including computer hardware and software, in accordance with some example embodiments of the invention. In some example embodiments, the control system incorporates a non-transitory machine-readable medium storing instructions that, when executed by one or more processors, execute various aspects of the present inventions described in this application. The generic and other components and aspects described herein are not exhaustive of the many different systems and variations, including a number of possible hardware aspects that might be used, in accordance with the example embodiments of the invention. Rather, the control system 500 shown depicts some example embodiments.

Control system 500 includes an input/output device 501, a memory device 503, long-term data storage device 505, and processor(s) 507. The processor(s) 507 is (are) capable of receiving, interpreting, processing and manipulating signals and executing instructions for further processing and for output, pre-output and/or storage in and outside of the system. The processor(s) 507 may be general or multipurpose, single- or multi-threaded, and may have a single core or several processor cores, including microprocessors. Among other things, the processor(s) 507 is/are capable of processing signals and instructions for the input/output device 501, to cause a user interface to be provided or modified for use by a user on hardware, such as, but not limited to, computer system peripheral devices, such as a mouse, keyboard, touchscreen and/or other display 519, providing specialized tools (e.g., providing a graphical user interface, a.k.a. a “GUI,” providing any of the GUI tools as set forth in this application, e.g., for regulating and generating content on a plurality of social media platforms, and, more specifically, for creating and managing proposed social media advertisements (both by an advertiser user and by administrators of a social media advertising rule compliance portal), developing Risk Score(s) and other alerts regarding content with a high risk of non-compliance with social media rules, and developing alternative advertising elements, in place of elements drafted by such an advertiser user, as set forth in greater detail elsewhere in this application. In some embodiments, such GUI tools are based on display-controlling and input-facilitating software (e.g., on local machine(s) 511, display 519 or smartphone 520).

For example, GUI tools and other user interface aspects, such as any of the graphical “windows,” “buttons,” and data entry fields, may present via, for example, a display, any number of selectable options, actions, commands and/or data entry fields set forth elsewhere in this application. When such options, actions and/or data entry fields are selected or data is entered by a user (e.g., an advertiser user), such selection and/or data entry causes aspects of the control system to command other aspects of the control system to take particular actions and present additional instructions, GUI tools or other guidance to the user related to processing a proposed social media advertisement for publication on a plurality of social media platforms, as set forth elsewhere in this application. For example, in some embodiments, the control system may generate a risk score, after running a rule application software module, and use machine learning and other artificial intelligence techniques to compare the content of the proposed social media advertisement to other templates, phrases, keywords, algorithms as set forth above, in this application. For example, in some embodiments, an administrative user may identify advertisements from a group of sample advertisements which raise higher risk of non-compliance with social media rules, in some embodiments, and, in some such embodiments, the control system may adjust a working algorithm it maintains, to include and define similarities between the samples with such higher risk of non-compliance, e.g., in a machine learning rule generator module. In some embodiments, the control system may facilitate recording data related to drafting and redrafting of versions of such social media advertisements. The processor(s) 507 may execute instructions stored in memory device 503 and/or long-term data storage device 505, and may communicate via system bus(ses) 575. Input/output device 501 is capable of input/output operations for the system, and may include and communicate through input and/or output hardware, and instances thereof, such as a computer mouse, scanning device or other sensors, actuator(s), communications antenna(ae), keyboard(s), smartphone(s) and/or PDA(s), networked or connected additional computer(s), camera(s) or microphone(s), a mixing board(s), real-to-real tape recorder(s), external hard disk recorder(s), additional movie and/or sound editing system(s) or gear, speaker(s), external filter(s), amp(s), preamp(s), equalizer(s), computer display screen(s) or touch screen(s). Such input/output hardware could implement a program or user interface created, in part, by software, permitting the system and user to carry out the user settings and input discussed in this application. Input/output device 501, memory device 503, data storage device 505, and processor(s) 507 are connected and able to send and receive communications, transmissions and instructions via system bus(ses) 575. Data storage device 505 is capable of providing mass storage for the system, and may be or incorporate a computer-readable medium, may be a connected mass storage device (e.g., flash drive or other drive connected to a Universal Serial Bus (USB) port or Wi-Fi), may use back-end (with or without middle-ware) or cloud storage over a network (e.g., the Internet) as either a memory backup for an internal mass storage device or as a primary memory storage means, or may simply be an internal mass storage device, such as a computer hard drive or optical drive. Generally speaking, the system may be implemented as a client/server arrangement, where features of the system are performed on a remote server, networked to the client and made a client and server by software on both the client computer and server computer. In any event, the system may include, or include network connections (e.g, wired, WAN, LAN, 5G, ethernet, satellite, and/or Internet connections) with, any of the example devices or auxiliary devices and/or systems, shown as Internet server(s) 509, local machine(s) 511, cameras and microphones 513, sensor(s) 514, internet of things or other ubiquitous computing devices 515, API 517, scanner 519 and smartphone 520. Similarly, the control system 500 is capable of accepting input from any of those auxiliary devices and systems, and modifying stored data within them and within itself, based on any input or output sent through input/output device 501.

Input and output devices may deliver their input and receive output by any known means, including, but not limited to, any of the hardware and/or software examples shown as internet server(s) 509, local machine(s) 511, cameras and microphones 513, sensor(s) 514, internet of things or other ubiquitous computing devices 515, API 517, display 519 and smartphone 520.

While the illustrated example of a control system 500 in accordance with the present invention may be helpful to understand the implementation of aspects of the invention, any suitable form of computer system known in the art may be used—for example, in some embodiments, a simpler computer system containing just a processor for executing instructions from a memory or transmission source. The aspects or features set forth may be implemented with, and in any combination of, digital electronic circuitry, hardware, software, firmware, middleware or any other computing technology known in the art, any of which may be aided with external data from external hardware and software, optionally, by networked connection, such as by LAN, WAN, satellite communications networks, 5G or other cellular networks, and/or any of the many connections forming the Internet. The system can be embodied in a tangibly-stored computer program, as by a machine-readable medium and propagated signal, for execution by a programmable processor. The many possible method steps of the example embodiments presented herein may be performed by such a programmable processor, executing a program of instructions, operating on input and output, and generating output and stored data. A computer program includes instructions for a computer to carry out a particular activity to bring about a particular result, and may be written in any programming language, including compiled and uncompiled and interpreted languages and machine language, and can be deployed in any form, including a complete program, module, component, subroutine, or other suitable routine for a computer program.

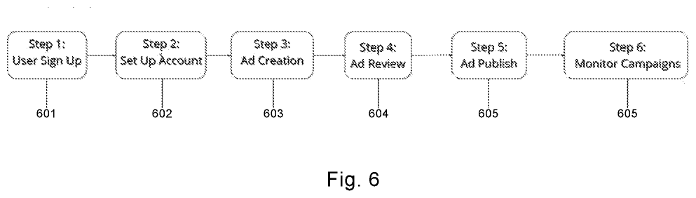

FIG. 6 is a process flow diagram, illustrating several additional example steps 600 that may be carried out with the aid of a control system, such as the example control system set forth above, in reference to FIG. 5, of a system regulating and generating content on a plurality of social media platforms, in accordance with some additional embodiments. Generally speaking, such a system may be part of a portal for aiding both social media advertisers and social media platforms in preventing the publication of advertising content that does not comply with social media advertising rules on the social media platforms, as discussed above. In some embodiments, such a portal is owned by a third party, other than the social media advertisers and social media platforms, and may charge a usage-based or licensing fee(s) to such social media advertisers and social media platforms, in some embodiments, for so using the portal. In some embodiments, less tangible forms of payments or benefits may be exchanged, other than fees, to incentivize use of the portal by some users. For example, in some embodiments, a social media platform may promise not to ban, strike or take other adverse action against an advertiser user, if the advertiser user publishes a social media advertisement using the system and/or portal.

Beginning with step 601, in some embodiments, the control system may present a GUI for an advertiser user, such as a GUI including sub-tools for creating an advertiser user account managed by the control system, as discussed elsewhere in this application. In some embodiments, the advertiser user must also provide the secure log-on details for an advertising account secured with the selected social media platforms, through which the portal can then publish social media advertisements on behalf of the advertiser user, in some such embodiments. In some embodiments, the portal creates new advertising accounts for the advertiser user, however (e.g., for an additional fee payment, secured through the portal) using an API of each such social media platform. The advertiser user may then perform certain set-up and/or configuration steps related to such an account, also as discussed in greater detail elsewhere in this application, in subsequent step 602. Following that, the advertiser may create a proposed social media advertisement, in step 603, again, as discussed in greater detail elsewhere in this application.

In subsequent step 604, in some embodiments, a human supervisor user with legal and/or computer training may, alternatively or in addition to aspects of a control system, review the proposed social media advertisement, and guide the advertiser user regarding the application of social media advertising rules, e.g., by furnishing any or all of the GUI tools set forth in the present application for guiding and advising an advertiser user to reduce a risk score.

In subsequent step 605, in some embodiments, the human user and/or control system publishes the proposed social media advertisement using the control system, if, and only if, it is determined that none of the content, copywriting, images and/or other elements of the proposed social media advertisement are non-compliant with any rules of the social media platforms (including public, private and community-based rules).

Finally, in step 606, in some embodiments, the advertiser user may monitor multiple advertising campaigns, and determine which campaigns perform better than others on the social media platforms, based on KPIs and other statistical data gathered, scraped from the APIs of the social media platforms, or generated by the control system, in various embodiments.

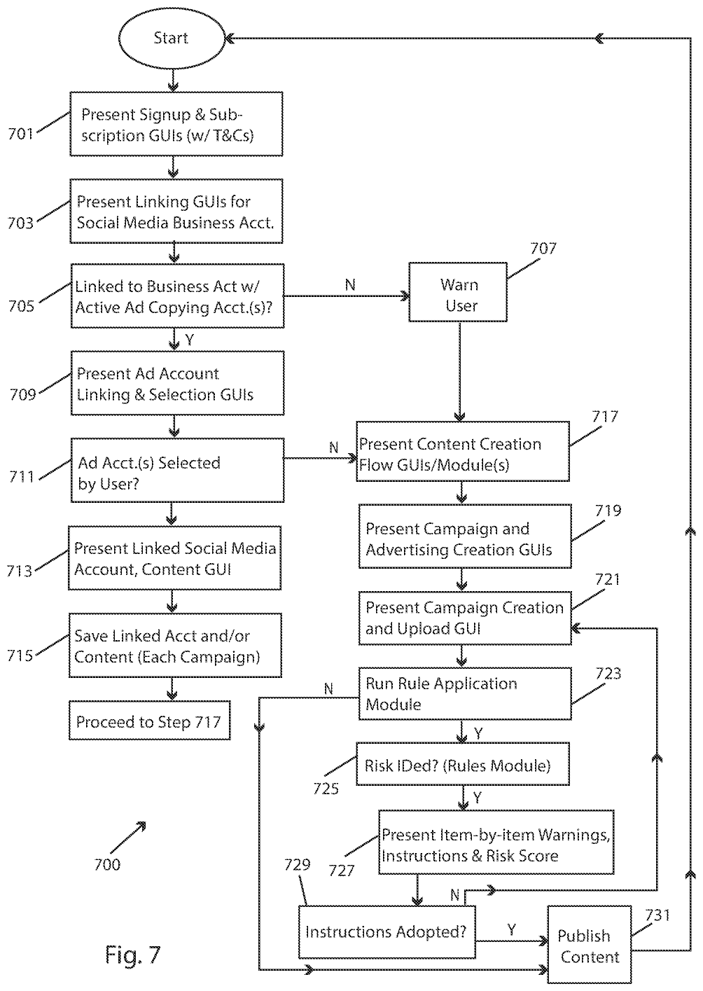

FIG. 7 is a process flow diagram, illustrating several example steps 700 that may be carried out by a control system, such as the example control system set forth below, in reference to FIG. 5, of a system regulating and generating content on one or more social media platform(s), in accordance with some additional embodiments.

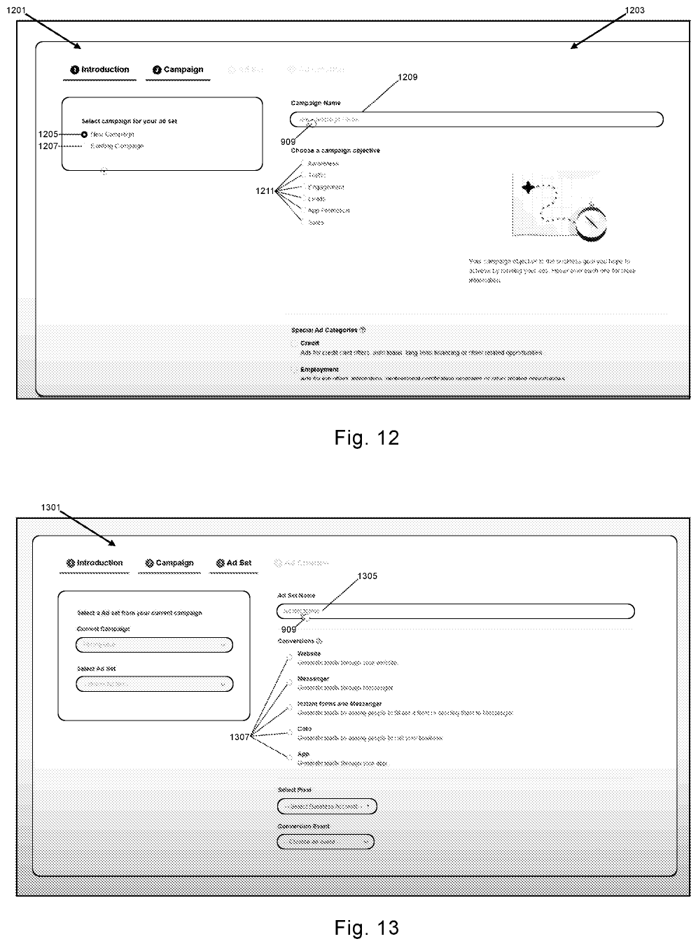

Beginning with step 701, in some embodiments, the control system first presents a GUI for an advertiser user, such as a GUI including sub-tools for creating an advertiser user account on the control system (such as any or all of the GUIs discussed in reference to Step 201 of FIG. 2, above), in some example embodiments. In some embodiments, such sub-tools and an advertiser user account includes secure login credentials (e.g., with a username, password and/or 2-factor authentication method). In some embodiments, the advertiser user may be presented with options for different types of advertiser user accounts, such as accounts with short- or long-term durations and/or accounts with different tiers or levels of privileges (e.g., in some embodiments, a higher cost account option, if selected and opened by the advertiser user using the GUI and sub-tools and control system, permits the advertiser user to upload, draft, review and/or publish a greater number of advertisements than a lower cost account option, when, instead, selected). As another example, and as mentioned previously, some types of advertiser user account options, if selected, may require a one-time payment or free trial, for processing and publishing a single social media advertisement, while other types of advertiser user accounts may require a payment for less limited use of the system, over a longer period of time (e.g., a month-by-month or one-year subscription), in various embodiments. In some embodiments, control system may implement a multiple-tiered (e.g., freemium) model, in which a lower level of accounts require a lower fee, or no fee, but provide less resources, less features (e.g., omitting GUI tools for revising advertising content) than higher lever account types, available for a higher fee. In some embodiments, as a prerequisite to opening any such optional account types, the control system requires the user to accept legally binding terms and conditions (e.g., via electronic signature) for creating, configuring and using the account for purposes set forth in this application. If the advertiser user does not accept the terms and conditions, in some embodiments, the user may be denied access to any of those GUI tools (e.g., with different GUI aspects informing the user that no account has been set up and that the user has been barred from access to those GUI tools), and the control system returns to the starting position, in some embodiments. However, in some embodiments, if the advertiser user accepts all required terms and conditions, the control system then proceeds to step 703, in which it presents a GUI to the advertiser user with GUI tools and sub-tools allowing the advertising user to link and provide access to one or more social media business account(s), maintained separately one or more social media platform(s). In some embodiments, such social media business account(s) may include tools (e.g., Application Programming Interfaces (“API's”)), access tools (e.g., login credentials), private personal and/or business information, privileges, settings, aiding in the placement of advertisements and/or managing advertising campaigns, on such a social media platform(s). Thus, in some embodiments, the control system may next determine, after a user provides such access to one or more linked social media business account(s), whether such a social media business account(s) presently has any such advertising campaigns running, or under development, in subsequent step 705. In some embodiments, if the linked business account does not have any stored information related to any such advertising campaigns, the control system then warns the advertising user, in step 707, with an indicator, such as a message presented within GUI tools, that “No Active or Draft Campaigns” were found in the linked social media business account(s). If, however, information related to one or more such advertising campaigns is found by the control system, in step 705, above, in some embodiments, the control system may present GUI tools permitting the user to select one or more such advertising campaign(s) for management via the control system and GUI tools set forth in this application (such as the example GUI tool 1207, as set forth in FIG. 12, below), in step 709. Subsequently, if the advertising user so selects such an advertising campaign, in step 711, the control system presents a specialized GUI presenting information and GUI tools related to such an advertising campaign, in step 713. In some embodiments, such information and tools include a link to advertising content already created on the social media platform(s) within such a campaign(s), which may be directly reviewable and editable via the control system based on the access to the social media business account, in some such embodiments. However, in some embodiments, in addition to or as an alternative to such direct review and editing, the control system separately stores any or all information relating to such advertising content and campaigns (e.g., on data storage computer hardware included within the control system), in step 715. The control system may then proceed to steps 717 et seq, in some embodiments, as discussed in detail immediately below.

If, in step 711, the advertising user does not so select an advertising campaign to review and/or edit, or, in steps 705 and 707, if the control system does not discover any active advertising campaigns, or campaigns under development, and so warns the user, in some embodiments, the control system next proceeds to steps 717 et seq., in which it presents additional GUI tools (such as any of the example GUI tools shown in FIGS. 3, 4 and 12-15, infra) aiding the advertiser user in creating new advertisement campaigns and advertisements to be run through the linked social media business account(s) on the respective social media platform(s). In some embodiments, also in step 717, the control system activates a rule application module (e.g., an artificial intelligence module), such as any of the rule application modules set forth in this application for determining a risk score, readying such a module for immediate application to content created and/or reviewed by the control system in subsequent steps.

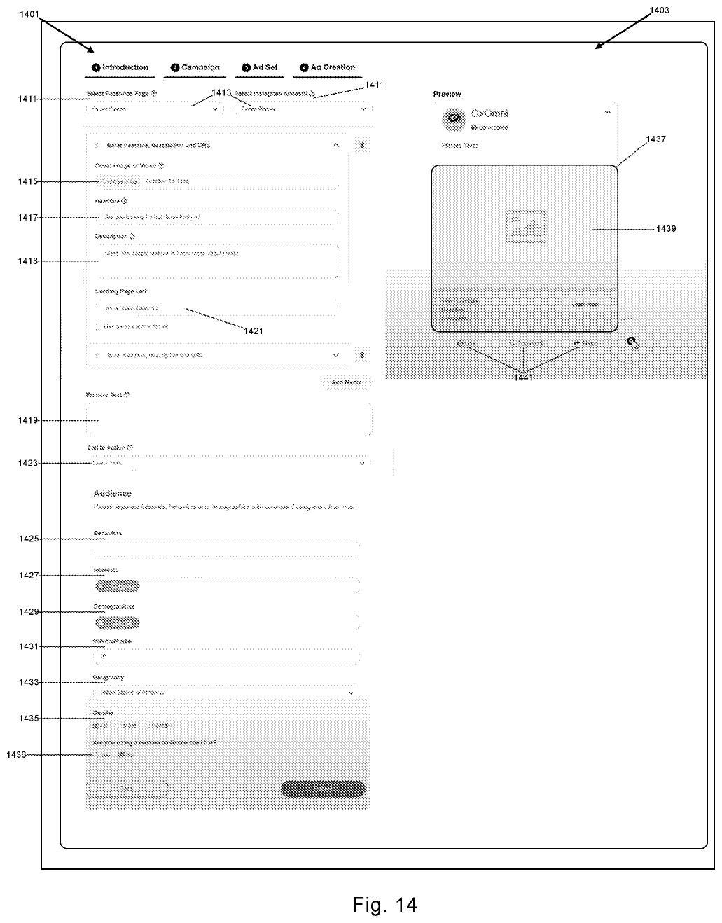

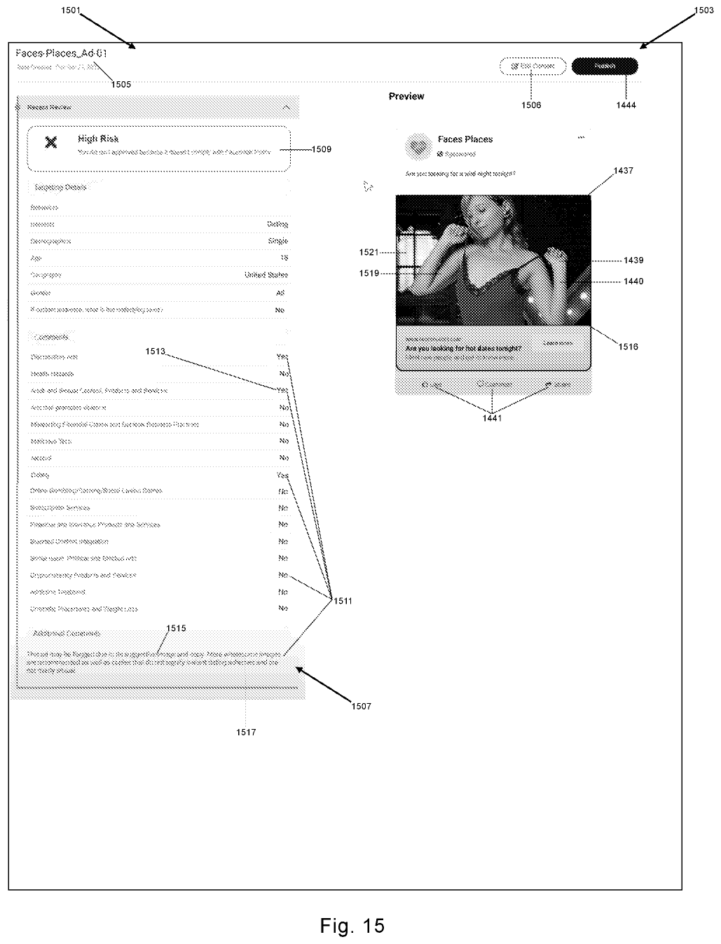

For example, in some embodiments, in step 719, the control system presents GUI tools enabling a user to create new advertisement campaigns and advertisements, to be reviewed and, depending on the outcome of such a review, published through such social media account(s) on such social media platform(s). In various embodiments, such campaign and advertisement creation tools may be any of the campaign and advertisement creation tools set forth in this application. For example, in some embodiments, some such campaign creation tools are set forth in the GUI examples provided in FIGS. 12 and 13. As another example, in some embodiments, such advertisement creation tools are set forth in the GUI examples provided in FIGS. 14 and 15.

In some embodiments, if the user does not so opt to create new content using such campaign and advertisement creation tools, the control system then proceeds to step 721, in which it presents a GUI to the advertiser user with GUI tools facilitating the uploading and processing of planned advertising campaign(s), along with proposed advertising content (e.g., imported from a linked social media business account, as discussed herein), in accordance with any and/or all of the aspects set forth in the present application for regulating and generating content on one or more social media platform(s), in various embodiments.

In any event, whether proposed content is uploaded and imported from a social media business account, as in step 721, and/or created with the aid of campaign and advertisement creation tools within the control system, as in step 719, the control system may next process the advertising content for any such advertisement (e.g., within any such campaign), in accordance with any methods for reviewing proposed social media advertising content set forth in this application, in subsequent step 723. For example, in some embodiments, the control system may activate and apply a rule application module to such content, as discussed above, to so process such content. For example, as also discussed above, in some embodiments, a user may press a “review” or “review and publish” GUI tool, and the control system may take a final application rule set, such as the final application rule set 115 discussed in reference to FIG. 1, and apply an algorithm for determining whether any and all of such rules, of the final application rule set 115, prohibit any proposed advertising content, as discussed elsewhere in this application. However, in some embodiments, in addition to, or as an alternative, the control system may allow one or more administrative users (e.g., authorized and credentialed by the control system and/or an owner of the advertiser user account as such an administrative user, with administrative privileges) to individually review and flag advertisements including content which does not comply, or has a high risk of non-compliance with, terms and conditions for advertising on the one or more social media platform(s), based on that administrative user's personal knowledge and/or opinion. For example, in some embodiments, the control system may provide individual flagging GUI tools to such an administrative user, on a review screen showing a matrix of add content, for such purposes.

Regardless of whether either or both of the rule application module and an administrative user review the advertising content, the control system may next render a Risk Score, in some embodiments, such as any of the Risk Scores set forth in this application, in step 725.

For example, in some embodiments, as discussed above, the control system includes a rule application module, such as the rule application module 131 set forth in reference to FIG. 1, to determine a risk score, and then reports that risk score back to the advertiser user in subsequent step 727. In some embodiments, in step 727, the control system also generates GUI tools for specifying content of the advertisement which has created some risk of non-compliance with the social media platforms'('s) terms and conditions for placing advertising content on the social media platform(s). In some embodiments, the control system also generates GUI tools for improving the risk score for the proposed advertising content. For example, some such GUI tools include specific warning(s), if and when some type(s), aspect(s) or part(s) of the proposed advertisement content has a high risk of non-compliance. As another example, in some embodiments, such a GUI tool may be in the form of a colored highlight of a word, phrase or image within the content. As another example, in some embodiments, such a GUI tool may be in the form of a nearby indicator, such as a red flag or “stop” sign icon, appearing on or about content of a proposed advertisement on a display of the system. In some embodiments, one or more GUI tool(s) identifies said terms, conditions and other rules that said proposed advertisement will not comply with. In some embodiments, the control system states reasoning regarding the non-compliance of such a type(s), aspect(s) or part(s) and/or specific suggestions regarding an approach to revising content which may lower the risk of noncompliance, as shown below, in reference to FIG. 15. In some embodiments, the advertiser user must adopt those suggestions, and other mandatory instructions, before the control system will permit the publication of the proposed advertisement, in step 731. In some embodiments, the system generates a new version of said proposed advertisement, e.g., by suggesting substitute content associated with a decreased likelihood that said a proposed advertisement will any of the rules discussed above, and presents additional GUI tools for the user to accept and publish, or further modify, the suggested substitute content. In some embodiments, such substitute content includes a version of the proposed social media advertisement in which the aspect(s) or part(s) of the proposed advertisement content that has a high risk of “non-compliance” is deleted, but not so replaced. In some embodiments, GUI tools identify which particular rule(s), and which social media platform(s) having such rule(s), are the basis for some aspect(s) or part(s) of the proposed advertisement content having a high risk of non-compliance. In some such embodiments, an advertiser user is provided with a GUI tool to remove such social media platforms previously designated for publication of the proposed advertisement, in a new designation of social media platforms, and re-run any of the processes above.

The control system then returns to the starting position, in some embodiments.

In some embodiments, an advertiser user (e.g., with particular credentials or other authorizations) may bypass the processing of the proposed advertisement, in step 723, and proceed to publish the proposed advertisement “at risk.” In some such embodiments, the advertiser user must accept all responsibility for the risk of non-compliance with the social media platform's('s) rules, pay a premium fee to an owner of the control system, and/or have a sufficient record of past compliance with the social media platforms' rules.

It should be understood that the above steps, and number and order of steps, is exemplary only of certain embodiments set forth in this application, and are not intended to limit the application in any way. In fact, virtually unlimited alternative orders, numbers, instances of the above steps, in addition with countless additional and alternative steps may be performed, within the scope of the present application and inventions herein, as will be readily apparent to those of skill in the art.

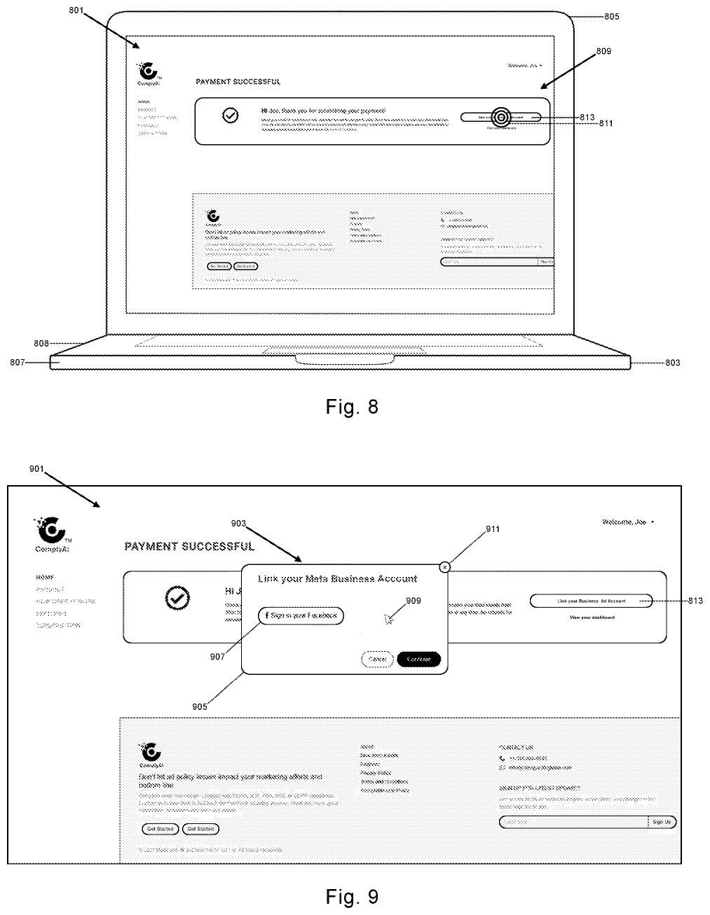

FIG. 8 depicts an example GUI 801, including some additional example GUI tools, which may be created and utilized by users of a system for regulating and generating content on one or more social media platform(s) (the “system”), in accordance with some embodiments. As with other example GUIs and GUI tools set forth in the present application, in some embodiments, GUI 301 and any such GUI tools may be provided within, and controlled by, a control system including computer hardware and software, such as, but not limited to, the example control system set forth below, in reference to FIG. 5, in some embodiments. In some embodiments, such a control system may include, or be included within, a computer 803, including local computer hardware, such as local display 805, and specialized software (e.g., a desktop software application, or “App”) which, when executed, causes some of the steps and processes set forth in this application to take place. But, if so, preferably, in some embodiments, computer 803 is connected for communications (e.g., to the internet, via wireless communications antenna 807) with another control system including computer hardware and software (e.g., a remote server), with additional specialized software (e.g., an SaaS web application) which, when executed, causes some of the steps and processes set forth in this application to take place. In some embodiments, a smartphone or other peripheral device-based app is included, as a part of, or in communication with, a control system included in case 808. However, the example of a local computer 803, and the example format of a laptop computer as pictured, is only one example of the virtually unlimited alternative forms and numbers of local and network-accessible computers that may be used to carry out aspects of the inventions set forth in this application. For example, in some embodiments, multiple such local computers are provided. As another example, no local computer is provided, and, instead, all GUI tools and processes may be carried out on a remote, cloud-based computer, or a single computer, which may or may not be a part of a network, in some embodiments. As another example, the format of a local computer may instead be a peripheral device, such as a smartphone or other personal digital assistant device, in some embodiments. In any event, any such computer may relay instructions and other information and monitor user selections, data input, and other user behavior, through GUI tools, such as the example GUI tools set forth below, to aid in carrying out the processes and steps set forth in this application.

In some embodiments, and assuming the advertiser user has already created and logged in to its account, as set forth in step 701, discussed above, such GUI tools may be such as those shown as example GUI tools 809. Generally speaking, GUI tools 809 facilitate an advertiser user in linking and providing access to the control system to a social media business account, of a social media platform, which the advertiser user also has authorized access to (in addition to the advertiser user account created and maintained on the control system). Thus, for example, by hovering example activated pointer 811 over, and clicking on and activating, example link and access consent button 813, in some embodiments, the advertiser user may indicate her or his intent to so link and access such a social media business account. In some embodiments, activated pointer 811 may take on an animated form, different from a conventional (e.g., arrow-shaped) pointer, upon such clicking on and activating (e.g., in the form of emanating concentric circles, as pictured) indicating to the user that she or he has successfully clicked on and activated a GUI tool, such as example link and access consent button 813. In response to such a selection, in some embodiments, the control system then proceeds to activate and present additional tools for such linking and activating, as discussed immediately below, in reference to FIG. 9.

FIG. 9 depicts some additional example GUI tools, included within example GUI 901, which may be provided on the same computer 803, which may be utilized by users of a system for regulating and generating content on one or more social media platform(s), in accordance with some embodiments. For simplicity, however, a computer, such as example computer 803, has been omitted in the present figure. In any event, as with other example GUIs set forth in this application, in some embodiments, GUI 901 and any such GUI tools included within it may be provided and controlled by a control system including computer hardware and software, such as, but not limited to, the example control system set forth below, in reference to FIG. 5, in some embodiments. In some embodiments, GUI 901 includes several of the same GUI tools set forth above, with reference to FIG. 8—for example, link and access consent button 813. However, after the advertiser user has activated link and access consent button 813, additional example GUI tools have been created by the system. For example, a specific social media platform linkage and access tool 903 has now been presented by the control system. In some embodiments, as pictured, specific social media platform linkage and access tool 903 may take the form of a “pop-up” and/or smaller dialogue window 905, presenting GUI sub-tool(s), such as example specific consent button 907, using which the advertiser user may indicate specific consent to link and provide access to the control system to such a specific social media platform. For example, as pictured, an advertiser user may hover a pointer, such as example conventional form factor pointer 909, over specific consent button 907, and click on it to activate it. In some embodiments, the control system may proceed to link a specific social media business account(s), as indicated by dialogue window 905 and specific consent button 907 (in this instance, a META and/or FACEBOOK social media business account.) For example, in some embodiments, the advertiser user may then be presented with a GUI tool including data entry fields for authenticating and confirming such a link and access (not pictured). In some embodiments, a user may cancel such a selection using pop-up GUI cancellation button 911, however, and return to the previous GUI (GUI 801), based on their preference, upon reviewing the specific social media business accounts indicated by dialogue window 905.

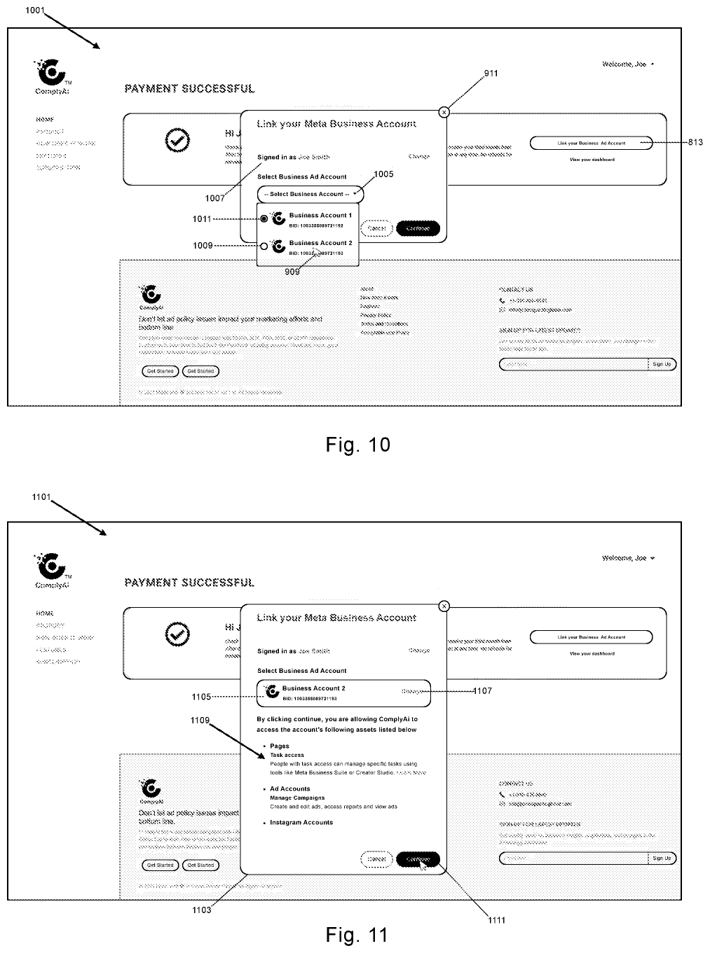

FIG. 10 depicts some additional example GUI tools, included within example GUI 1001, which may be provided on the same computer 803, as discussed above, which may be utilized by users of a system for regulating and generating content on one or more social media platform(s), in accordance with some embodiments. For simplicity, however, as with FIG. 9, a computer, such as example computer 803, has been omitted in the present figure. As with other example GUIs set forth in this application, in some embodiments, GUI 1001 and any such GUI tools included within it may be provided and controlled by a control system including computer hardware and software, such as, but not limited to, the example control system set forth below, in reference to FIG. 5, in some embodiments.

In some embodiments, GUI 1001 includes several of the same GUI tools set forth above, with reference to FIGS. 8 and 9. However, after the advertiser user has activated specific social media platform linkage and access tool 903, as discussed above, additional example GUI tools have been created by the system. For example, an additional drop-down menu activating button 1003 is presented, including a drop-carrot 1005 which, when activated by the user clicking on it, creates a drop-down tool—namely, social media business account selection drop-down menu 1007, which is now presented to the user within GUI 1001, as an addendum to, and abutting, “pop-up” and/or smaller dialogue window 905, discussed above. In some embodiments, every social media business account owned and/or managed by the advertiser user may be represented within social media business account selection drop-down menu 1007 within actuable areas or buttons, such as the examples shown as business account selection actuable area or button 1009 and business account selection actuable area or button 1011. In some such embodiments, by hovering conventional form factor pointer 909 over either of business account selection actuable area or button 1009 and/or business account selection actuable area or button 1011, and clicking on or otherwise activating them, the advertiser user may select the respective business accounts indicated. After such selection, in some embodiments, the advertiser user may then user other GUIs, discussed herein, to control the drafting, review and/or publication of advertisements on a social media platform associated with the selected business account(s). In some embodiments, the control system may also present a version of GUI 1101 providing similar GUI tools for selecting sub-accounts of each social media business account. For example, in some embodiments, such a sub-account may include one or more advertising accounts, each being indicated by a similar list or other grouping of account selection actuable areas and/or buttons.

FIG. 11 depicts some additional example GUI tools, included within example GUI 1101, which may be provided on the same computer 803, as discussed above, which may be utilized by users of a system for regulating and generating content on one or more social media platform(s), in accordance with some embodiments. For simplicity, however, as with FIGS. 9 and 10, a computer, such as example computer 803, has been omitted in the present figure. As with other example GUIs set forth in this application, in some embodiments, GUI 1101 and any such GUI tools included within it may be provided and controlled by a control system including computer hardware and software, such as, but not limited to, the example control system set forth below, in reference to FIG. 5, in some embodiments.

In some embodiments, GUI 1101 includes several of the same GUI tools set forth above, with reference to FIG. 10. However, after the advertiser user has selected a social media business account, according to the techniques set forth above—e.g., as pictured, a social media business account titled “Business Account 2”—a further expanded version of “pop-up” and/or smaller dialogue window 905 appears, as expanded pop-up window 1103. In some embodiments, the social media business account so identified also includes a unique account number shown by example currently selected account identifier 1105. In some embodiments, the advertiser user may change her or his selection of such an indicated social media business account, but clicking on or otherwise activating a social media business account selection tool, such as example change account button 1107. In some embodiments, after clicking on or otherwise activating change account button 1107, the control system may return to presenting GUI 1001, as discussed above. In some embodiments, expanded pop-up window 1103 may disclose information regarding the types of information and other access to linked and shared with the control system, for use in additional techniques set forth in this application, from the identified social media business account, in a linkage and account access disclosure area 1109 of expanded pop-up window 1103, as pictured. In some embodiments, the system will not proceed to presenting such further techniques and/or GUIs unless and until the advertiser user confirms that she or he has read and understood the information provided in account access disclosure area 1109 and/or wishes to proceed notwithstanding such information. For example, in some embodiments, the advertiser user may so confirm by affirmative clicking on and activating a GUI tool so indicating, such as example “Continue” button 1111. After such selection, in some embodiments, the advertiser user may then user other GUIs, discussed herein, to control the drafting, review and/or publication of advertisements on a social media platform associated with the selected business account(s).

FIG. 12 depicts an additional example GUI 1201, including some additional example GUI tools 1203, included within it, which may be utilized by users of a system for regulating and generating content on one or more social media platform(s), such as any of such systems set forth in the present application, in accordance with some embodiments. As with other GUIs set forth in the present application, GUI 1201 may be presented by computer hardware, in some embodiments. For simplicity, however, a computer, such as example computer 803, has been omitted in the present figure. In any event, as with other example GUIs set forth in this application, in some embodiments, GUI 1201 and any such GUI tools included within it are provided and controlled by a control system including computer hardware and software, such as, but not limited to, the example control system set forth below, in reference to FIG. 5, in some embodiments.

Generally speaking, GUI tools 1203, as with other GUIs of the immediately previous and following figures, facilitate an advertiser user, as discussed above, in regulating and generating content on one or more social media platform(s), in accordance with some embodiments, by creating one or more advertising campaign(s). In addition to its ordinary meaning, within the meaning of the present application, an advertising campaign means a planned and/or managed course of actions, arranged using GUI tools of a control system, to advertise, promote and/or market one or more products or services. As discussed above, in some embodiments, advertising campaigns may be created and managed using GUI tools of a control system set forth in the present application. In some such embodiments, an advertiser user may initiate such a creation of one or more advertising campaign(s) by activating and/or selecting a new advertising campaign initiation tool of GUI tools 1203—such as example new advertising campaign initiation button 1205, in some embodiments.

In some such embodiments, such advertising campaigns, although planned and initiated using the control system, may result in running advertisements, promotions and/or marketing actions on social media platform(s) linked to such a control system, such as any of the linked social media platforms discussed above. In some such embodiments, the social media platform(s) may also maintain similar campaigns (social media platform advertising campaign(s)) based on the advertising campaigns created on the control system, in embodiments where the advertiser user has granted access to social media advertising campaign creating tools of the social media platform to the control system, as discussed in various embodiments above.

In some embodiments, however, the control system may create advertising campaigns based on social media platform advertising campaigns already planned and/or maintained on one or more social media platforms. Because such an advertiser user has consented, and granted access to their social media business account(s) previously, as discussed above, the control system may access data related to such social media advertising campaigns (e.g., advertising copy, images, videos, pricing, linked media, and other advertising content) and plan one or more advertisements or other marketing actions based on that information, in some embodiments. In some such embodiments, the advertiser user may make edits to such campaigns, which may, in some such embodiments, be reflected in the social media advertising campaigns maintained on the social media platform as well, in addition to the advertising campaign being directly edited on the control system, using GUI 1201 and/or other content creation GUIs set forth in this application. To elect to manage such an advertising campaign on the control system, originating from such a social media advertising campaign, in some embodiments, the advertiser user may activate and select an existing social media advertising campaign with an existing campaign selection tool 1207, of GUI tools 1203, in some embodiments.

In response to either such a selection, in some embodiments, the control system then proceeds to activate and present additional tools for creating an advertising campaign and processing and editing content for advertisement(s) or other marketing efforts to be made through such a campaign and the control system, as discussed further below.

For example, in some embodiments, GUI tools 1203 include a campaign naming tool, such as that shown as example campaign naming tool 1209, in some such embodiments. In some embodiments, campaign naming tool 1209 may, as pictured, be in the form of a data entry window which, when clicked into (e.g., using example pointer 909) allows a user to enter a title or other identifier for a campaign to be created using additional GUI tools of the control system. The advertiser user may next assign an intended objective for the advertising campaign being created, by clicking on or otherwise selecting and activating any of the types of campaign objectives shown within campaign selection buttons 1211, in some embodiments. In some such embodiments, the control system will subsequently aid the advertiser user, for example, using specialized GUI tools and advertising campaign enhancements (e.g., demographic and other advertisement targeting and presentation tools) based on any or all such objectives that have been selected. For example, in some embodiments, the advertiser user may select the objective “Engagement,” and, as a result, the control system may activate tools (e.g., software sub-modules selecting more engaged or interested social media users for viewing advertisements of an advertising campaign) leading to, or encouraging more views, clicks on embedded links, likes and/or other indicators of engagement by an audience for an advertisement or other content of the advertising campaign, in some embodiments.

In some embodiments, GUI tools 1203 may include additional tools which, when activated and/or selected, indicate special advertising categories for an advertising campaign (not pictured, but appearing below the pictured GUI tools 1203 if a user scrolls the GUI downwards, using a computer on which GUI 1201 is displayed. In some embodiments, such special advertising categories may include buttons or other tools with indicators of such special categories, which, in some embodiments, may be categories of advertisement and/or other marketing content which are subject to special rules and rule sets of the linked social media platform on which the advertising would appear, if the created campaign is approved. For example, in some embodiments, one such special category is the category of credit-related advertising, such as advertisements for credit card offers, automobile loans, long-term or alternative financing offers, and/or related opportunities for the advertisement audience. As another example, in some embodiments, one such special category is the category of employment-related advertising, such as advertisements for employment, internship, contracting, job training and certification, or related opportunities. As another example, in some embodiments, one such special category is the category of housing-related advertising, such as advertisements for real estate opportunities, such as apartments for rent, houses for rent or sale, condominiums for rental or sale, homeowner's or rental insurance, mortgages, or related opportunities. As another example, in some embodiments, one such special category is the category of social- and/or politically-related advertising, such as advertisements related to elections, political movements, and social issues, such as the economy, social equity and civil rights. After the advertiser user selects all such applicable categories, in some embodiments, the control system will then activate specialized software modules and/or submodules, in addition to the software modules and/or submodules as set forth, e.g., in FIG. 1, above. In some embodiments, the control system may include additional libraries of policy statements, e.g., within existing modules of the content management and creation aspects of the control system, again, as set forth, e.g., in FIG. 1, above.

FIG. 13 depicts an additional example GUI 1301, including some additional example GUI tools 1303, included within it, which also may be utilized by users of a system for regulating and generating content on one or more social media platform(s), such as any of such systems set forth in the present application, in accordance with some embodiments. As with other GUIs set forth in the present application, GUI 1201 may be presented by computer hardware, in some embodiments. For simplicity, however, a computer, such as example computer 303 or computer 803, has been omitted in the present figure. In any event, as with other example GUIs set forth in this application, in some embodiments, GUI 1201 and any such GUI tools included within it are provided and controlled by a control system, including or included in computer hardware and software of a computer similar to computer 303 or 803, such as, but not limited to, the example control system set forth above, in reference to FIG. 5, in some embodiments.

In some embodiments, after initiating the creation of advertising campaign(s), assigning a title to such campaign(s), and indicating objectives and designating appropriate special categories, as discussed above in reference to FIG. 12, the control system next presents GUI tools 1303, which include tools for designating a set of advertisements (each including advertising content to be served to an audience of social media users) as part of such an advertising campaign (an “Ad Set”). In some embodiments, GUI tools 1303 include an As Set naming tool, such as that shown as example Ad Set naming tool 1305. In some embodiments, campaign naming tool 1305 may, as pictured, be in the form of a data entry window which, when clicked into (e.g., using example pointer 909) allows a user to enter a title or other identifier for an Ad Set to be created using additional GUI tools of the control system.

In some embodiments, the advertiser user may next designate a manner in which advertisements within the Ad Set will generate sales leads for the advertiser user, e.g., using example conversation/lead type selection tools 1307. For example, and as pictured, in some embodiments, such a lead type may be a website lead, in which a user clicking on or otherwise interacting with an advertisement within the Ad Set is sent to the advertiser user's website (e.g., to register and/or order product(s) or service(s)), as indicated by the identifier of example conversation/lead type selection tools 1309, and so on.

Next, in some embodiments, an advertiser user may use tracking pixel selector/creator tool 1311, to generate a tag or other tracking element to be placed on all advertisements within the Ad set, in some embodiments.

In some embodiments, upon so designating one or more Ad Sets for a campaign, the user may proceed to upload and generate content for individual advertisement(s) within the Ad Set, and process those advertisements using any of the GUI tools and techniques discussed above, for example, in reference to FIGS. 1-5, in some embodiments. More specifically, in some embodiments, the control system may next present the GUIs set forth in reference to FIGS. 3 and 4, for regulating and generating advertising content, which is then published on the one or more linked social media platforms. However, in some embodiments, alternative forms of such GUIs are presented by the control system, instead, as discussed immediately below.

FIG. 14 depicts an example GUI 1401, including some example GUI tools 1403, which may be utilized by users of a system for regulating and generating content on one or more social media platform(s), such as any of such systems set forth in the present application, in accordance with some embodiments. As with other example GUIs and GUI tools set forth in the present application, in some embodiments, GUI 1401 and any such GUI tools included within it are provided within, and controlled by, a control system including or included in computer hardware and software of a computer similar to example computer 303, as discussed above, such as, but not limited to, the example control system set forth below, in reference to FIG. 5, in some embodiments.

As with several other GUI tools set forth above, generally speaking, GUI tools 1403 facilitate an advertiser user creating and publishing a social media advertisement, and reducing the risk that such a social media advertisement will result in adverse impacts, such as ultimately being taken down by one or more social media platforms selected by the advertiser user for publishing such a social media advertisement, and negatively impacting other users of the social media platform, in the interim.

For example, one such GUI tool is pictured as social media platform designation tools 1411, which, in some embodiments, permit the advertiser user to select any of one or more available social media platform(s), the social media advertising rules of which are accessible and processed by the system, as discussed above, in reference to FIGS. 1 and 2. In some embodiments, multiple such social media platforms may be owned by a single company, as pictured, with the instance of FACEBOOK and INSTAGRAM, each presently being owned by Meta Platforms, Inc. To aid in selecting any of the available social media platforms, social media platform designation tool 1411 may include several sub-tools, such as example account and/or social media page data entry tools 1413. By “clicking in” to one or more of data entry tools 1413, and entering a unique identifier for a social media page owned or managed by the advertiser user within the indicated platform, in some embodiments, the social media platform indicated will be selected. Because those selected social media platforms have been so selected, the social media advertising rules, as discussed above, will be included within the processes to be carried out, as discussed further below (and throughout this application) if and when the advertiser user continues to use GUI 1401 and the system to create, review and/or publish a social media advertisement. After making such selections, the advertiser user may then begin a social media advertisement creation processes using others of GUI tools 1403, e.g., beginning with media file selection and upload tool 1415, in some embodiments. Media file selection and upload tool 1415 is shown as button-format GUI tool which can be activated (e.g., by the advertiser user “clicking on” them, using an input device of a computer on which GUI 1401) is being displayed. In some embodiments, when so clicked on and activated, media file upload tool 1415 allows the user to select a file(s) (e.g., from any data storage device available through the control system) for uploading as a source of content for a proposed social media advertisement. Once so selected, in some embodiments, the advertiser user then may click on file selection and upload tool 1415, which input causes the control system to upload the file(s) (e.g., to a control system managed on a remote server) and make it available as content for a proposed social media advertisement, as will be discussed further below. In some embodiments, the advertiser user also may create a headline for such a proposed social media advertisement, for example, using headline/title data entry window 1417, in some embodiments, to be presented to any user that is part of the audience for the advertisement being created. In some embodiments, headline/title data entry window 1417 may be pre-populated with a file name of the file uploaded. In some embodiments, a user may click on data entry window 1417 and enter text creating a title. In some embodiments, the advertiser user may be prompted to enter a general description of the advertisement being created, as pictured, in description data entry window 1418. In some embodiments, based on the advertiser user's entry of words, phrases or symbols through such data entry windows and tools, the control system may designate the advertisement being created as having a subject matter, or being of a type of advertisement requiring the use of special, additional social media platform rules and/or software modules and submodules, as such rules, modules and submodules are discussed above, in reference to creating a final application rule set, and cause the creation and application of a modified final application rule set when processing the content of the advertisement being created, in some embodiments. Similarly, in some embodiments, any entry of data, links, or other information, through any of the GUI tools 1403, may be determined by the control system to require the addition and processing of such additional social media platform rules, modules and/or submodules to the advertisement being created, in some embodiments.

As another example, the advertiser user may create text for advertisement copywriting for a main body of the social media advertisement, by clicking on copywriting data entry window 1419, and again entering text creating such copywriting for the primary text of the advertisement being created. In some embodiments, the advertiser user may enter a link (e.g., based on a URL) to a website or other resource, for example, using landing page data entry window 1421. In some embodiments such a link may be included in the proposed social media advertisement, to allow viewers of the social media advertisement to quickly navigate to the advertiser user's webpage, telephone number, chat account, or other resource, when viewing the social media advertisement. In some embodiments, a statement may be placed along with a navigable link within the advertisement, if and when the advertisement is later published, to that resource. In some embodiments, a statement may appear as a part of, near, or otherwise in relation to that navigable link, to identify the navigation and later activation of that resource for the audience (a “Call to Action). In some embodiments, the advertiser user may select or enter such a call to action, using Call to Action data entry tool 1423, in some embodiments. As mentioned above, in some embodiments, the system accesses and scrapes a website or other resource of the advertiser user (e.g., for determining a risk score, or supplemental risk score), may then be generated by the system, based on processing of content (e.g., using rule application module 131) of the website or other resource of (e.g., owned by) the advertiser user. In some such embodiments, such a website may be the webpage or other resource so entered.

In some embodiments, a user may identify particular types of audiences of social media users that the advertisement being created will be most useful or effective for. For example, in some embodiments, the advertiser user may enter: particular behaviors (e.g., time spent within the social media platform viewing or interacting with similar content as present in the advertisement) using Behaviors data entry tool 1425; interests (e.g., night life, fashion, sports, travel, automobiles, etc.) and/or sub-interests thereof, using Interests data entry tool 1427; other demographic information, using Demographics data entry tool 1429; age groups (e.g., adult material, suitable only for social media users of a particular minimum age), using Minimum Age data entry tool 1431; geographic location or residence, using Geography data entry tool 1433; and/or the gender identity, using Gender data entry tool 1435, of the social media users desired to be within the audience receiving the advertisement on the designated social medial platform(s). As with the particular data entered using others of GUI tools, based on the advertiser user's entry of words, phrases or symbols through any of the data entry tools set forth immediately above, and their entry within those particular categories of audience demographics and information, the control system may designate the advertisement being created as having a subject matter, or being of a type of advertisement requiring the use of special, additional social media platform rules and/or software modules and submodules, as discussed above, in reference to creating a final application rule set, and cause the creation and application of a modified final application rule set when processing the content of the advertisement being created, in some embodiments. Similarly, in some embodiments, any entry of data, links, or other information, through any of the GUI tools 1403, may be determined by the control system to require the addition and processing of such additional social media platform rules, modules and/or submodules to the advertisement being created, in some embodiments.

In some embodiments, an advertiser user may opt to upload contact and other information of particular parties to be added to the audience for the proposed advertisement being drafted with the aid of the system, by activating custom audience seed list GUI tool 1436. In some such embodiments, the system may require the advertiser user to confirm that they have obtained the necessary legal permissions and consents from any person or party whose personal information is included in such a list, and for the intended targeting of the proposed advertisement to them. In some embodiments, the system will not permit the publication of the proposed advertisement to receiving parties unless and until such a confirmation is made (e.g., by a click-wrap agreement GUI tool (not pictured)).

In some embodiments, the system is configured to generate a preview of the proposed social media advertisement, including and showing the advertising copywriting, and other content from the uploaded file(s) and title, among other possible elements, e.g., within a preview displaying tool 1437, in some embodiments. In some embodiments, preview displaying tool 1437 includes a viewing area 1439 for viewing advertising art, such as an image(s) and/or video(s), which may be included in the proposed social media advertisement. In some embodiments, drafts of the proposed social media advertisement may be saved, sent to third parties, annotated, or otherwise developed and shared, using draft social media advertisement sharing and commenting tools 1441. The proposed social media advertisement may then be subjected to additional editing by the advertiser user, at a later time, in some embodiments.

In any event, once satisfied with the substance and preview seen in viewing area 1439, and other aspects of the draft advertisement shown through GUI tools 1403, the advertiser user may then trigger the system to process the content, copywriting, audience information, metatags or other metadata, and other data entered using GUI tools 1403, and/or linked content, as discussed in greater detail elsewhere in this application, by clicking on, and activating, a process-initiating GUI tool, such as example process button 1443, in some embodiments. For example, in some embodiments, such a process-initiating GUI tool causes the system to carry out at least some aspects of step 209, step 211 and/or step 213, using rule application module 131, each of which are discussed above, in some embodiments, to any and all such content, copywriting, information, metadata, or other data. Example results of such processing will be discussed in further detail, below, in reference to FIG. 15.

FIG. 15 depicts another example GUI 1501, including additional example GUI tools 1503, which may be utilized by users of the system for regulating and generating content on one or more social media platforms, in accordance with some embodiments. As with other example GUIs set forth in this application, GUI 1501 and any such GUI tools included within it may be provided and controlled by a control system including computer hardware and software, such as, but not limited to, the example control system set forth below, in reference to FIG. 5, in some embodiments. In some embodiments, GUI 1501 includes several of the same GUI tools set forth above, with reference to FIG. 1401—for example, preview displaying tool 1437, including a viewing area 1439 displaying a preview image of an image(s) and/or video(s) 1440, which may be included in the proposed social media advertisement, and draft social media advertisement sharing and commenting tools 1441. However, after the processing, discussed above, following the advertiser user's activating example submission/publication button 1444, additional example GUI tools have been created by the system.

Some such GUI tools may be modified relative to how related aspects were manifested in FIG. 14, reflecting changes entered by the advertiser user. For example, the title data entered using title data entry window 1417 now appears in an advertisement title display tool 1505, above the remainder of GUI tools 1503. And, generally speaking, although much of the data previously entered by the advertiser user using GUI tools 1403 are visible in various respective processing outcome display tools, those data are not directly editable, in some embodiments. Instead, to make changes to those data, a user must first activate an “edit” button 1506 (e.g., by clicking on it), and, in some embodiments, the advertiser user may be returned to GUI 1401 upon doing so. To aid the advertiser user in determining whether such editing, results of processing the content and other data related to the advertisement being created with the aid of the control system are indicated through a plurality of processing results indicators, such as example processing results indicators 1507, which, together, exhibit a range of different levels of subject matter specificity. The processing results indicators may each indicate whether the particular data, content or other aspects of the advertisement, carry a particular level of risk of noncompliance with rules, and special rules (as discussed above), applicable to that type of data, content, or other aspect of the advertisement, after carrying out at least some aspects of step 209, step 211 and/or step 213, using rule application module 131, each of which are discussed above, in some embodiments, to any and all such content.

One example of such an additional GUI tool and indicator is shown as example processing completion and general risk indicator 1509, which indicates to the advertiser user that such processing has been completed, and indicates the overall level of risk that the advertisement may be non-compliant with such rules, based on that processing. Others of processing results indicators 1507—namely, item-specific processing results indicators, such as the example item-specific processing results indicators 1511, indicate whether the indicated entered data (appearing next to them, to the left, in the example provided) specifically carry a risk of such non-compliance and, in some embodiments, a level of such risk (e.g., on a scale of 1-10, or No, Average, and High risk) that that particular data or other aspect will be non-compliant with those rules. For example, item-specific processing results indicator 1513 indicates that the advertisement relates to “adult and sexual content . . . ” and poses significant risk of noncompliance. As another example, item-specific processing results indicator 1515 indicates that both the uploaded media (image) and copy created for the advertisement may be overly suggestive, sexual content. In addition, in some embodiments, some or all of processing completion and general risk indicator 1509 and item-specific processing results indicators 1511 may include guidance tools, specifying suggested edits to the advertisement that may reduce the risk of non-compliance, such as example guidance tool 1517.

In some embodiments, a new form of preview displaying tool 1516 now appears, reflecting changes in the content and video created and uploaded by the advertiser user, and rendering a simulation of the appearance and content of the proposed social media advertisement, in some embodiments. Because the advertiser user has uploaded a video file, using media file selection and upload tool 1415, in the example pictured, a preview of an image, including at least one image 1519 (e.g., of a woman undressing) now appears in a media display area 1521 of the preview displaying tool 1505. As discussed elsewhere in this application, in some embodiments, such images and video files are scanned by the system, which then determines whether there is a risk that prohibited content is included within the proposed social media advertisement (e.g., by rule application module 131 of a control system of the system), and, in some embodiments, a level of that risk. As an example, if the rule application module includes a rule that any advertisement on the particular, selected social media platform(s) (e.g., Facebook and Instagram) involving dating services, must not use overtly sexual imagery, the control system may apply a machine learning sub-system included within it, trained with sets of images determined to be overtly sexual imagery, for determining whether particular uploaded images are overtly sexual in nature, and therefore, prohibited. In some such embodiments, to aid in such training, and/or to determine whether imagery of the advertisement is overtly sexual or otherwise non-compliant with rules, another, human user may routinely, and individually review and flag advertisements as being compliant or non-compliant with such rules, as discussed in relation to Fig. R, below.

In some embodiments, any of the risk-indicators may be modified, and show a lower, or no, risk of non-compliance, if the advertiser user edits and revises the identified potentially non-compliant content or data.

In some embodiments, if the content, images and other elements of the proposed social media advertisement, when processed as discussed in this application, generate a risk score below a particular threshold, the advertiser user may then immediately publish the proposed social media advertisement, on each of the selected social media platforms, as discussed above. In some embodiments, an API provided by another party may be used to aid the system in immediately and directly publishing the social media advertisement across the selected social media platforms. Thus, in some embodiments a GUI tool for the advertiser user to command such publishing, such as submission/publication button 1444, is included. However, in some embodiments, each selected social media platform may be required to sign a legal contract with the owner of the system, to permit such immediate publication upon command. In some embodiments, as another option, an advertiser user may deselect social media platforms, to eliminate the selection of social media platforms not agreeing to expedited and/or more limited review of the social media advertisement prior to publication. Similarly, in some embodiments, the advertiser user may so eliminate the selection of social media platforms, rules associated with which are leading to an adverse risk score (e.g., a risk score below a required threshold for publication) in some embodiments.

As discussed above, following the publication of the social media advertisement, in some embodiments, the system provides ongoing statistics and other data related to the publication of the social media advertisement to a number of users of the social media platforms selected (a.k.a, a “campaign”). For example, in some embodiments, such data may include key performance indicators (“KPIs”) relevant to the effectiveness of the social media advertisement, on each social media network. In some embodiments, multiple campaigns may be so managed by a single advertiser user, who may then adopt changes based on the differing results of each such campaign. In some embodiments, the system may generate additional suggestions for revising the content, data and/or copywriting of the social media advertisement(s), based on results of the different campaigns. For example, in some embodiments, the control system includes a machine learning module, using data related to KPIs demonstrating better outcomes than others as a positive outcome, and then uses examples of advertisements with such a positive outcome to evolve an algorithm including functions that define differences from example advertisements that have a more negative outcome, over time. The control system may then apply that algorithm to generate suggestions for changes, based on elements identified as correlated with positive and negative outcomes in new, proposed social media advertisements, in some embodiments. In some embodiments, a flagged advertisement, or other advertisement determined to be non-compliant are such example advertisements that have a more negative outcome. In some such embodiments, a flagged advertisement, or other advertisement determined to be non-compliant with social media platform rules, are such example advertisements that have a more negative outcome are used to create a revised risk score, based on such a machine learning algorithm.

What is claimed is:

1. A content creation and management system, comprising:
a control system, including specialized computer hardware and software, configured to:
create an advertiser user proposed draft advertisement configured to be published on one or more social media platform(s), based on content and other data uploaded and/or drafted by said advertiser user on said control system;
assess terms, conditions and other rules adopted by each of said one or more social media platforms, which terms, conditions and other rules impact content advertised on any of said one or more social media platforms, via a Natural Language Processing module of said specialized computer hardware and software;
assess common rules, and/or overlapping rule aspects, among said terms, conditions and other rules adopted by each of said plurality of social media platforms, based, at least in part, on the entry of similar data by multiple other users of a data entry tool eliciting data of the same type, which is later flagged by a social media community;
create an algorithm for applying said terms, conditions and other rules and common rules, and/or overlapping rule aspects, to said content for a proposed advertisement;
determine a Risk Score based on a likelihood that said content and/or other data for said advertiser user proposed draft advertisement will not comply with said terms, conditions and other rules and common rules, and/or overlapping rule aspects, based on said algorithm for applying said terms, conditions and other rules and common rules, and/or overlapping rule aspects.

2. The content creation and management system of claim 1, comprising:
a graphical user interface (“GUI”) comprising GUI tools:
facilitating the entry of said content and other data for said advertiser user proposed draft advertisement;
identifying parts of said content and other data for said advertiser user proposed draft advertisement related to said likelihood that said content and other data will not comply with said terms, conditions and other rules and common rules, and/or overlapping rule aspects.

3. The content creation and management system of claim 2, wherein said GUI comprises GUI tools:
presenting a new version of said advertiser user proposed draft advertisement with a decreased likelihood that said content for a proposed advertisement will not comply with said terms, conditions and other rules and common rules, and/or overlapping rule aspects.

4. The content creation and management system of claim 1, wherein said one or more social media platform(s) comprise a plurality of social media platforms.

5. The content creation and management system of claim 1, wherein said GUI identifies said terms, conditions and other rules and common rules, and/or overlapping rule aspects that said proposed advertisement will not comply with.

6. The content creation and management system of claim 4, wherein the system determines whether said advertiser user proposed draft advertisement is approved or disapproved for publication on any of said one or more social media platform(s).

7. The content creation and management system of claim 6, wherein the system publishes said advertiser user proposed draft advertisement if said proposed advertisement is approved for publication.

8. The content creation and management system of claim 1, wherein said control system identifies, crawls and/or scrapes data from a website owned or managed by said advertiser user, and determines a supplemental Risk Score that content of said website owned or managed by said user.

9. The content creation and management system of claim 6, wherein said GUI is configured to:
identify parts of said website related to said supplemental Risk Score;
present GUI tools proposing website edits and information related to decreasing a likelihood that said website will not comply with said terms, conditions and other rules and common rules, and/or overlapping rule aspects.

10. A computer program, comprising instructions which, when executed by a computer, cause a computer to carry out the following steps:
create an advertiser user proposed draft advertisement configured to be published on one or more social media platform(s), based on content and other data uploaded and/or drafted by said advertiser user on said control system;
assess terms, conditions and other rules adopted by each of said one or more social media platforms, which terms, conditions and other rules impact content advertised on any of said one or more social media platforms, via a Natural Language Processing module of said specialized computer hardware and software;
assess common rules, and/or overlapping rule aspects, among said terms, conditions and other rules adopted by each of said plurality of social media platforms, based, at least in part, on the entry of similar data by multiple other users of a data entry tool eliciting data of the same type, which is later flagged by a social media community;
create an algorithm for applying said terms, conditions and other rules and common rules, and/or overlapping rule aspects, to said content for a proposed advertisement;
determine a Risk Score based on a likelihood that said content and/or other data for said advertiser user proposed draft advertisement will not comply with said terms, conditions and other rules and common rules, and/or overlapping rule aspects, based on said algorithm for applying said terms, conditions and other rules and common rules, and/or overlapping rule aspects.

11. The computer program of claim 10, comprising instructions which, when executed by a computer, cause a computer to carry out the following additional steps:
creating a graphical user interface (“GUI”) comprising GUI tools:
facilitating the entry of said content and other data for said advertiser user proposed draft advertisement;
identifying parts of said content and other data for said advertiser user proposed draft advertisement related to said likelihood that said content and other data will not comply with said terms, conditions and other rules and common rules, and/or overlapping rule aspects.

12. The computer program of claim 11, wherein said GUI tools:
present a new version of said advertiser user proposed draft advertisement with a decreased likelihood that said content for a proposed advertisement will not comply with said terms, conditions and other rules and common rules, and/or overlapping rule aspects.

13. The computer program of claim 10, wherein said one or more social media platform(s) comprise a plurality of social media platforms.

14. The computer program of claim 10, wherein said GUI identifies said terms, conditions and other rules and common rules, and/or overlapping rule aspects that said proposed advertisement will not comply with.

15. The computer program of claim 13, wherein the system determines whether said advertiser user proposed draft advertisement is approved or disapproved for publication on any of said one or more social media platform(s).

16. The computer program of claim 15, wherein the system publishes said advertiser user proposed draft advertisement if said proposed advertisement is approved for publication.

17. The computer program of claim 10, wherein said control system identifies, crawls and/or scrapes data from a website owned or managed by said advertiser user, and determines a supplemental Risk Score that content of said website owned or managed by said user.

18. The content creation and management system of claim 17, wherein said GUI is configured to:
identify parts of said website related to said supplemental Risk Score;
present GUI tools proposing website edits and information related to decreasing a likelihood that said website will not comply with said terms, conditions and other rules and common rules, and/or overlapping rule aspects.
